(19) United States
(12) Patent Application Publication
(10) Pub. No.: US 2026/0303155 A1
(43) Pub. Date: Oct. 1, 2026

(54) SIGNAL LAYER COMBINATION PRECODING INDICATION SIGNALING

(71) Applicant: QUALCOMM Incorporated, San Diego, CA (US)

(72) Inventors: Aviv REGEV, Tel aviv (IL); Ronen SHAKED, Kfar Saba (IL); Amit BAR-OR TILLINGER, Tel-Aviv (IL); Amit MOSES, Givatayim (IL)

(21) Appl. No.: 19/091,636

(22) Filed: Mar. 26, 2025

(51) Int. Cl. H04B 7/0456; H04W 72/23

(52) U.S. Cl. CPC H04B 7/0456; H04W 72/23

(57) ABSTRACT

This disclosure provides methods, components, devices and systems for signal layer combination precoding indication signaling. For example, a network entity may precode a set of layers of a signal on a per precoding group basis in accordance with one or more layer combination configurations. Each precoding group of a set of precoding groups associated with the per precoding group basis may include a respective subset of the plurality of layers. The network entity may then transmit, to a user equipment (UE), the precoded set of layers of the signal, that were precoded by the network entity, and an indication of the one or more layer combination configurations used to precode the plurality of layers on the per precoding group basis.

### TECHNICAL FIELD

This disclosure relates generally to wireless communication, and more specifically to systems, devices, methods, and techniques associated with signal layer combination precoding indication signaling.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

One innovative aspect of the subject matter described in this disclosure can be implemented in a method for wireless communications by a network entity is described. The method includes precoding, at the network entity, a set of multiple layers of a signal on a per precoding group basis in accordance with one or more layer combination configurations, each precoding group of a set of multiple precoding groups associated with the per precoding group basis including a respective subset of the set of multiple layers and transmitting, to a UE, the set of multiple layers of the signal and an indication of the one or more layer combination configurations used to precode the set of multiple layers on the per precoding group basis.

Another innovative aspect of the subject matter described in this disclosure can be implemented in a network entity for wireless communications is described. The network entity includes a processing system that includes processor circuitry and memory circuitry that stores code. The processing system may be configured to cause the network entity to precode, at the network entity, a set of multiple layers of a signal on a per precoding group basis in accordance with one or more layer combination configurations, each precoding group of a set of multiple precoding groups associated with the per precoding group basis including a respective subset of the set of multiple layers and transmit, to a UE, the precoded set of multiple layers of the signal and an indication of the one or more layer combination configurations used to precode the set of multiple layers on the per precoding group basis.

Another innovative aspect of the subject matter described in this disclosure can be implemented in a network entity for wireless communications is described. The network entity includes means for precoding, at the network entity, a set of multiple layers of a signal on a per precoding group basis in accordance with one or more layer combination configurations, each precoding group of a set of multiple precoding groups associated with the per precoding group basis including a respective subset of the set of multiple layers and means for transmitting, to a UE, the set of multiple layers of the signal and an indication of the one or more layer combination configurations used to precode the set of multiple layers on the per precoding group basis.

Another innovative aspect of the subject matter described in this disclosure can be implemented in a non-transitory computer-readable medium storing code for wireless communications is described. The code includes instructions executable by one or more processors to precode, at the network entity, a set of multiple layers of a signal on a per precoding group basis in accordance with one or more layer combination configurations, each precoding group of a set of multiple precoding groups associated with the per precoding group basis including a respective subset of the set of multiple layers and transmit, to a UE, the precoded set of multiple layers of the signal and an indication of the one or more layer combination configurations used to precode the set of multiple layers on the per precoding group basis.

In some examples of the method, network entities, and non-transitory computer-readable medium described herein, the indication of the one or more layer combination configurations may include operations, features, means, or instructions for a downlink message transmitted to the UE prior to or with the set of multiple layers of the signal, the downlink message including, for each precoding group of the set of multiple precoding groups associated with the per precoding group basis, a respective precoding group index and an indication of a respective layer combination configuration, of a plurality of layer combination configurations that includes the one or more layer combination configurations, for precoding the respective subset of the set of multiple layers of the respective precoding group.

Some examples of the method, network entities, and non-transitory computer-readable medium described herein may further include operations, features, means, or instructions for selecting the one or more layer combination configurations for precoding respective subsets of the set of multiple layers associated with the plurality of precoding groups associated with the per precoding group basis in accordance with a balancing policy, a modulation and coding scheme at the network entity, or a signal to noise ratio threshold between layers, or any combination thereof.

Some examples of the method, network entities, and non-transitory computer-readable medium described herein may further include operations, features, means, or instructions for receiving, from the UE, an uplink signal associated with a change to a power-saving mode at the UE, where the set of multiple layers of the signal may be precoded on the per precoding group basis in accordance with the one or more layer combination configurations in association with the reception of the uplink signal.

Some examples of the method, network entities, and non-transitory computer-readable medium described herein may further include operations, features, means, or instructions for receiving, from the UE, a message indicating one or more capabilities of the UE, the one or more capabilities of the UE associated with a power level of the UE, support for a power-saving mode at the UE, or support for a recharging mode at the UE, or any combination thereof, where the set of multiple layers of the signal may be precoded on the per precoding group basis in accordance with the one or more layer combination configurations in accordance with the one or more capabilities of the UE.

Some examples of the method, network entities, and non-transitory computer-readable medium described herein may further include operations, features, means, or instructions for receiving, from the UE, a request for the network entity to use a particular layer combination configuration of the one or more layer combination configurations, where the set of multiple layers of the signal may be precoded on the per precoding group basis in accordance with the particular layer combination configuration in association with the reception of the request.

In some examples of the method, network entities, and non-transitory computer-readable medium described herein, the indication of the one or more layer combination configurations may include operations, features, means, or instructions for a downlink message transmitted to the UE prior to or along with the precoded set of multiple layers of the signal, the downlink message including, for the precoding group basis, an indication of two or more respective precoding group indices and an indication of a respective layer combination configuration, of a plurality of layer combination configurations that includes the one or more layer combination configurations, for precoding the respective subset of the set of multiple layers of two or more respective precoding groups.

A method for wireless communications by a UE is described. The method may include receiving, from a network entity, a precoded set of multiple layers of a signal that is precoded on a per precoding group basis in accordance with one or more layer combination configurations and an indication of the one or more layer combination configurations used to precode the precoded set of multiple layers of the signal, each precoding group of a set of multiple precoding groups associated with the per precoding group basis including a respective subset of the set of multiple layers and decoding, at the UE and on the per precoding group basis, the precoded set of multiple layers of the signal in accordance with the indication of the one or more layer combination configurations used to precode the precoded set of multiple layers on the per precoding group basis.

A UE for wireless communications is described. The UE may include a processing system that includes processor circuitry and memory circuitry that stores code. The processing system may be configured to cause the UE to receive, from a network entity, a precoded set of multiple layers of a signal that is precoded on a per precoding group basis in accordance with one or more layer combination configurations and an indication of the one or more layer combination configurations used to precode the set of multiple layers of the signal, each precoding group of a set of multiple precoding groups associated with the per precoding group basis including a respective subset of the precoded set of multiple layers and decode, at the UE and on the per precoding group basis, the precoded set of multiple layers of the signal in accordance with the indication of the one or more layer combination configurations used to precode the precoded set of multiple layers on the per precoding group basis.

Another UE for wireless communications is described. The UE may include means for receiving, from a network entity, a precoded set of multiple layers of a signal that is precoded on a per precoding group basis in accordance with one or more layer combination configurations and an indication of the one or more layer combination configurations used to precode the precoded set of multiple layers of the signal, each precoding group of a set of multiple precoding groups associated with the per precoding group basis including a respective subset of the precoded set of multiple layers and means for decoding, at the UE and on the per precoding group basis, the precoded set of multiple layers of the signal in accordance with the indication of the one or more layer combination configurations used to precode the precoded set of multiple layers on the per precoding group basis.

A non-transitory computer-readable medium storing code for wireless communications is described. The code may include instructions executable by one or more processors to receive, from a network entity, a precoded set of multiple layers of a signal that is precoded on a per precoding group basis in accordance with one or more layer combination configurations and an indication of the one or more layer combination configurations used to precode the precoded set of multiple layers of the signal, each precoding group of a set of multiple precoding groups associated with the per precoding group basis including a respective subset of the precoded set of multiple layers and decode, at the UE and on the per precoding group basis, the precoded set of multiple layers of the signal in accordance with the indication of the one or more layer combination configurations used to precode the precoded set of multiple layers on the per precoding group basis.

In some examples of the method, user equipment (UEs), and non-transitory computer-readable medium described herein, the indication of the one or more layer combination configurations may include operations, features, means, or instructions for a downlink message from the network entity that may be received prior to or along with the precoded set of multiple layers of the signal, the downlink message including, for each precoding group of the set of multiple precoding groups associated with the per precoding group basis, a respective precoding group and an indication of a respective layer combination configuration, of a plurality of layer combination configurations that includes the one or more layer combination configurations, for precoding the respective subset of the precoded set of multiple layers of a respective precoding group.

Some examples of the method, user equipment (UEs), and non-transitory computer-readable medium described herein may further include operations, features, means, or instructions for transmitting, to the network entity, an uplink signal associated with a change to a power-saving mode at the UE, where the indication of the one or more layer combination configurations used to precode the precoded set of multiple layers of the signal may be accordance with the change to the power-saving mode at the UE.

Some examples of the method, user equipment (UEs), and non-transitory computer-readable medium described herein may further include operations, features, means, or instructions for transmitting, to the network entity, a message indicating one or more capabilities of the UE, the one or more capabilities of the UE associated with a power level of the UE, support for a power-saving mode at the UE, or support for a recharging mode at the UE, or any combination thereof, where the indication of the one or more layer combination configurations used to precode the precoded set of multiple layers of the signal may be accordance with the one or more capabilities of the UE.

Some examples of the method, user equipment (UEs), and non-transitory computer-readable medium described herein may further include operations, features, means, or instructions for transmitting, to the network entity, a request for the network entity to use a particular layer combination configuration of the one or more layer combination configurations, where the indication of the one or more layer combination configurations used to precode the precoded set of multiple layers of the signal may be in association with the request.

### BRIEF DESCRIPTION OF THE DRAWINGS

FIG. 1 shows an example of a wireless communication system.

FIG. 2 shows an example of a signaling configuration that supports signal layer combination precoding indication signaling.

FIG. 3 shows an example of a process flow that supports signal layer combination precoding indication signaling.

FIG. 4 shows a block diagram of a processing system that supports signal layer combination precoding indication signaling.

FIG. 5 shows a diagram of a system including a device that supports signal layer combination precoding indication signaling.

FIG. 6 shows a block diagram of a processing system that supports signal layer combination precoding indication signaling.

FIG. 7 shows a diagram of a system including a device that supports signal layer combination precoding indication signaling.

FIGS. 8 through 9 show flowcharts illustrating methods that support signal layer combination precoding indication signaling.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, wireless communication devices may precode data using singular value decomposition (SVD) techniques. In some examples, wireless communication devices may utilize SVD precoding to ensure that data is transmitted through relatively strong directions of a channel (e.g., directions where a signal to noise ratio (SNR) is high). In some cases, SVD precoding techniques may include a wireless communication device multiplying stream vectors with a precoder that includes singular values of a channel before the signal passes through the channel. However, if the layers of a signal have unequal SNR values, utilizing the SVD precoding may result in a decreased capacity as the signal may be constrained to a singular modulation coding scheme (MCS) across the layers and the wireless communication device may select the singular MCS based on the lowest SNR value between the layers of the signal. In some cases, to increase the capacity, wireless communication devices may utilize an SVD combiner precoder that results in each layer of a signal having the same SNR value by utilizing the average of the SNR values between the layers of the signal. However, although the SVD combiner precoder may increase the throughput of communications relative to some techniques, the complexity of a decoder may increase. When a network entity uses an SVD precoder, the capacity of a signal to a user equipment (UE) may then be reduced. Moreover, when a network entity uses the SVD combiner precoder, the complexity of a decoder at the UE may increase, resulting in an increase in power consumption and resources. Utilization of the SVD precoder or the SVD precoder for precoding a signal may lead to an increase in latency due to the decrease in signaling capacity or the increase in decoder complexity which can result in a decrease in efficiency and reliability of a wireless communications system, among other challenges.

Various aspects generally relate to a network entity indicating one or more layer combination configurations used to precode a signal so a UE can determine how to decode a signal, and more specifically, to the network entity utilizing one or more layer combination configurations to precode the signal on a per precoding group basis. For example, the network entity may determine that—rather than precoding an entire signal according to one precoding technique—the network entity may precode a set of layers of a signal in accordance with one or more layer combination configurations (e.g., one or more SVD techniques) on a per precoding group basis. Each precoding group associated with the per precoding group basis may include a subset of layers of the signal such that the network entity may be capable of precoding different subsets of layers with different layer combination configurations. The network entity may transmit the signal and an indication of how each precoding group of the signal is precoded (for example, transmitting together in a same transmission or separately). For example, the network entity may precode a subset of layers of a respective precoding group by refraining from combining any of the layers of the respective precoding group, partially combining the layers of the respective precoding group, or by combining all the layers of the respective precoding group. In some examples, the network entity may transmit, prior to or in conjunction with the signal, a downlink message that includes an indication of the one or more layer combination configurations used to precode each precoding group of a set of precoding groups of the signal on the per precoding group basis. The UE may use the information in the downlink message to decode set of layers of the signal on the per precoding group basis according to the indication of the one or more combination configurations used to precode each precoding group of the signal on the per precoding group basis. Moreover, the one or more layer combination configurations may include a partial SVD combiner precoder that balances SNR values between layers of a precoding group without combining each layer of the precoding group.

Particular aspects of the subject matter described in this disclosure may be implemented to realize one or more of the following potential advantages. The techniques employed by the described wireless communication devices may enable a UE to reduce a demodulation complexity and increase a capacity of a signal. For example, operations performed by the described wireless communication devices may provide improvements to demodulation procedures. In some implementations, by having a network entity indicate the one or more layer combination configurations used to precode each precoding group of a signal, the UE may reduce the complexity of decoding at least portions (e.g., some precoding groups) of the signal. In some implementations, the network entity using a layer combination configuration associated with partially combining layers may also result in decreased decoding complexity at a UE due to the partial combination of multiple layers. Moreover, a partial layer combination for precoding portions of a signal may reduce the decoding complexity at the UE while increasing the capacity of a signal based on having relatively equal SNR values across layers while refraining from combining all the layers of the signal (e.g., compared combining all the layers of a signal or refraining from combining any of the layers of a signal). The techniques of the present disclosure described herein may result in improved decoding simplification and improved signal capacity to ensure that communications of a wireless communication system are relatively more efficient and reliable, among other various advantages.

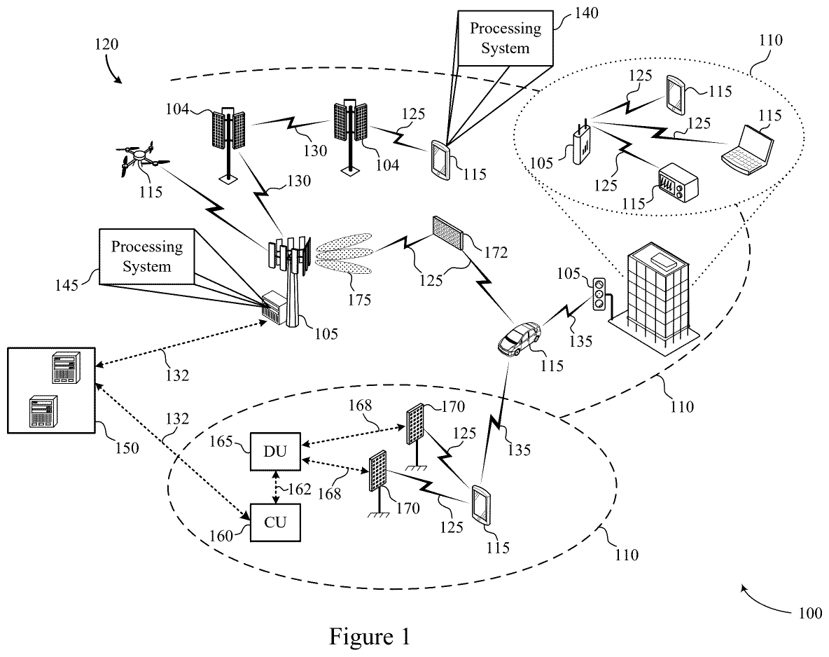

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Beamforming techniques may include analog beamforming, for which at least some signal processing (such as phase shifting, amplification, signal combination) is performed in an analog domain (such as using analog components, including analog phase shifters and amplifiers, for processing respective signals of individual antenna elements). Additionally (such as in accordance with hybrid beamforming), or alternatively, beamforming techniques may include digital beamforming, for which at least some signal processing is performed in a digital domain (such as using digital processing techniques for processing respective signals of individual antenna elements).

A network entity 105 or a UE 115 may use beam sweeping techniques as part of beamforming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a specific receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105, a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by receiving according to different receive beamforming weight sets applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

Devices in the wireless communication system 100 (such as network entities 105, UEs 115) may modulate and code information prior to transmission of a signal (such as of a physical channel). A modulation and coding scheme (MCS) may define how modulation and coding is to be performed, which may include an implementation in accordance with a modulation order and a target code rate. A code rate may be achieved using a channel coding scheme such as forward error correction (FEC) (such as to add redundancy). Examples of FEC include block codes, convolutional codes, and linear error-correcting codes. At a receiver (such as to demodulate modulation symbols of a physical channel), a decoder may employ probabilistic or iterative techniques to perform soft decision-making, and code blocks for bit streams may employ a check code (such as a cyclic redundancy check (CRC) code, a low-density parity-check (LDPC)) to detect and correct decoding errors.

Wireless communication devices of the wireless communication system 100 may be configured to support one or more aspects of the described techniques for signal layer combination precoding indication signaling. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support a network entity 105 precoding a set of layers of a signal by precoding each layer separately or by combining each layer to balance the SNR values between the layers of the signal.

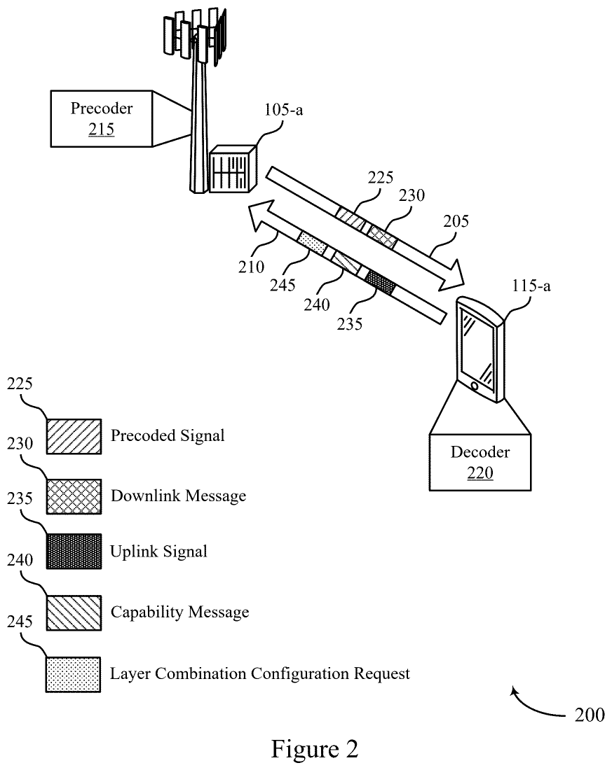

However, one or more precoding techniques (e.g., SVD techniques or SVD combiner precoder techniques) utilized by a network entity 105 may result in either decreased capacity for a signal or increased demodulation complexity at a UE 115. In accordance with the techniques of the present disclosure, the network entity 105 may precode a set of layers of a signal in accordance with one or more layer combination configurations on a per precoding group basis. The network entity 105 may then be capable of precoding different subsets of layers with different layer combination configurations. The network entity 105 may then transmit, to a UE 115, the precoded signal and an indication of how each precoding group of the signal is precoded. In some examples, by indicating the layer combination configuration used to precode each precoding group of a signal, the described techniques can be used to enable the UE 115 to reduce the complexity of decoding the signal. In some examples, having a network entity utilize a layer combination configuration associated with partially combining layers may result reducing the decoding complexity at the UE 115 while increasing the capacity of a signal compared combining all the layers of a signal or refraining from combining any of the layers of a signal. The techniques of the present disclosure described herein may result in improved decoding complexity and improved signal capacity to ensure that communications of a wireless communication system are relatively more efficient and reliable, among other benefits. Further descriptions of the techniques of the present disclosure may be described elsewhere herein, such as with reference to FIGS. 2 through 9.

FIG. 2 shows an example of a signaling configuration 200 that supports signal layer combination precoding indication signaling. In some examples, the signaling configuration 200 may implement or be implemented by the wireless communication system 100. For example, the signaling configuration 200 may be related to operations of a UE 115-a and a network entity 105-a, which may represent examples of corresponding devices described herein with reference to FIG. 1. The network entity 105-a may communicate with the UE 115-a via a communication link 205 (e.g., a downlink communication link) and the UE 115-a may communicate with the network entity 105-a via a communication link 210 (e.g., an uplink communication link. The communication link 205 and the communication link 210 may be examples of a Uu link, a sidelink, a backhaul link, a D2D link or some other type of communication link 125 described herein with reference to FIG. 1. Further, the network entity 105-a may use a precoder 215 to precode a signal and the UE 115-a may use a decoder 220 to decode the corresponding signal. The techniques of the present disclosure described herein may relate to decreasing the complexity of the decoder 220 at the UE 115-a based on the precoding techniques that the network entity 105-a may utilize via the precoder 215. Further, the techniques of the present disclosure may relate to increasing the efficiency and reliability of a wireless communication system (e.g., the wireless communication system 100) by having the network entity 105-a indicate how each precoding group of a signal is precoded by the precoder 215.

In some examples, the signaling configuration 200 may illustrate a closed loop system in an OFDM-MIMO system. In some examples, within the OFDM-MIMO system, the network entity 105-a may precode data with the precoder 215 corresponding SVD which may improve the spectral efficiency of communications between the network entity 105-a and the UE 115-a and mitigate demodulation complexities. When utilizing SVD for precoding data, the network entity 105-a may be capable of ensuring that one or more transmission antennas of the network entity 105-a are transmitting the data through the relatively strongest directions of a channel (e.g., the directions where the SNR satisfies a threshold or is maximized). In some examples, SVD techniques may include the network entity 105-a multiplying the stream vectors, x, of a signal with a precoder 215, p, that includes the singular vectors of the channel, H. In some examples, using SVD precoding may ensure that a signal (e.g., a precoded signal 225) is transmitted in the relatively stronger directions of a channel (e.g., the communication link 205). Further, determining the quantity of spatial streams (e.g., layers) of a signal, Nₛₛ, the singular values of a channel (e.g., the eigen values of the matrix H^{H} H), σ=[σ₁, σ₂ . . . ], the additive white gaussian noise (AWGN) power at the receive antennas of the UE 115-a,

$${σ}_{n}^{2} ,$$

and the transmitted signal power,

$${σ}_{x}^{2} ,$$

an expected SNR of the i^{th} stream (e.g., 1≤i≤Nₛₛ) may be the baseline SNR indicated via Equation 1 below multiplied by a gain of the i^{th} singular value of the channel as indicated via Equation 2 below.

$$SNR = \frac{{σ}_{x}^{2}}{{σ}_{n}^{2} {N}_{ss}} \qquad ( 1 )$$

$${SNR}_{i} = {σ}_{i}^{2} * SNR = \frac{{σ}_{i}^{2} {σ}_{x}^{2}}{{σ}_{n}^{2} {N}_{ss}} \qquad ( 2 )$$

Further, having the network entity 105-a utilize SVD precoding may result in a MIMO system that is equivalent to a system of Nₛₛ parallel SISO links which may reduce the receiver demodulation complexity (e.g., the complexity of the decoder 220 at the UE 115-a). For example, the SVD precoding may lead to a precoded channel, Hp, which may be relatively easy to equalize due to relatively little or no noise enhancement and the channel matrix being diagonal. Such techniques may also lead to relatively dramatic reductions in the demodulation complexity capabilities. For example, SVD precoding may reduce the complexity of the matrix inversion, O(n³), in the equalizer to the complexity of a diagonal matrix inversion, O(n).

However, although SVD precoding may assist in transmitting a signal (e.g., the precoded signal 225) through the directions with the relatively strongest (e.g., highest) SNR values, the network entity 105-a may be expected to use a same MCS for all the layers of the signal. For example, because each transmitted stream has a different SNR, each stream would have to be configured with a different MCS to have the network entity 105-a experience the full SNR gain from SVD precoding. However, because the network entity 105-a may be unable to enable multiple MCSs (e.g., a different MCS per layer), the weakest stream or layer of a signal (e.g., the stream or layer associated with the relatively weakest singular value) may limit and dictate the performance of the signal transmission. For example, the operated MCS for a signal may be configured (e.g., via an RRC configuration) such that the UE 115-a may successfully demodulate and decode, via the decoder 220, each one of the streams or layers of the signal. The stream or layer with the weakest SNR value may then dictate which MCS the network entity 105-a may utilize when transmitting the signal.

In some examples, a signal may include four layers (e.g., Nₛₛ=4) and the demodulation of an exemplified 1 k-QAM MCS may be associated with an SNR threshold of 30 decibels (dB). In some examples, if even one layer fails to satisfy the SNR threshold, the network entity 105-a may have to use a lower MCS to ensure that the UE 115-a can decode the precoded signal 225. For example, three out of four of the layers of a signal may be associated with SNR values that satisfy the SNR threshold (e.g., SNR values equal or greater than 30 dB) and a fourth layer may be associated with an SNR value that fails to satisfy the SNR threshold (e.g., the SNR value of the fourth layer may be below 30 dB). To enable the successful decoding of the precoded signal 225 at the UE 115-a via the decoder 220, the network entity 105-a may use a lower MCS. Further, such issue of the lowest SNR dictating the MCS selection may be unable to be solved by using an interleaver across the layers. For example, because each code block (CB) may experience all four levels of SNRs, the lowest SNR may still dominate and dictate the selection of an MCS for operation at the network entity 105-a. The network entity 105-a may then determine (e.g., select) an MCS to utilize for transmission of the precoded signal 225 based on the stream with the lowest SNR to ensure that the UE 115-a can decode and demodulate each stream or layer of the precoded signal 225 via the decoder 220, which may result in reduced performance by using SVD in a single MCS configuration.

In some examples, to increase the performance capabilities, the network entity 105-a may use a precoder 215 that is an SVD combiner precoder. The SVD combiner precoder may combine the strongest singular eigen vectors corresponding to singular values equally among different streams in order to guarantee that each stream attains the same SNR value. In some examples, the precoder 215 may add a relatively simple product of a unitary and equal power entries matrix to the typical SVD precoding matrix, resulting in a combination of all the different (e.g., relatively stronger singular vectors.

For example. an observed signal may be given by yₖ (e.g., yₖ=Hₖpₖxₖ+nₖ) where Nᵣₓ is a quantity of receive antennas, NTₓ is a quantity of transmit antennas, and Nₛₛ is a quantity of streams such that yₖ∈(NRₓ, 1) is the receive signal, Hₖ∈(Nᵣₓ, NTₓ) is the channel, pₖ∈(NTₓ, Nₛₛ) is the precoder (e.g., the precoder 215), xₖ∈(Nₛₛ, 1) are the transmitted streams, nₖ∈(Nᵣₓ, 1) is the additive nose, and k is the frequency index. As such, a standard SVD precoder may suggest to use the first strongest Nₛₛ singular eigen vectors as the precoder such that Pₖ=Vₖ(:,1:Nₛₛ) where

$$( svd ( {H}_{k} ) = {U}_{k} {\sum }_{k} {V}_{k}^{′} ) .$$

Further, if it is determined that the receiver may multiply the received signal, yₖ, by

$${U}_{k}^{′} ,$$

the observed signal may be indicated by Equation 3 below.

$${\tilde{y}}_{k} = {U}_{K}^{′} {y}_{k} = {U}_{K}^{′} ( {H}_{k} {p}_{k} {x}_{k} + {n}_{k} ) = {U}_{K}^{′} {U}_{K} {\sum }_{k} {V}_{k}^{′} {V}_{k} {x}_{k} + {\tilde{n}}_{k} = {\sum }_{k} {x}_{k} + {\tilde{n}}_{k} \qquad ( 3 )$$

Moreover, a resultant SNR for the i^{th} stream may be indicated via Equation 2 above where each stream may be separate from the other streams. To balance the SNR values of the streams, a different precoder, Pₖ, may be used that is based on a relatively special square matrix, aₖ (e.g., aₖ∈(Nₛₛ, Nₛₛ):Pₖ=Vₖ(:,1:Nₛₛ)*aₖ. Moreover, to ensure a fully balanced SNR between all the streams (e.g., to ensure each stream of the precoded signal 225 has the same SNR value), each of a entries may have the same power. A normalized fast Fourier transform (FFT) matrix may be indicated via Equation 4 below.

$${α}_{k} ( m , n ) = \frac{1}{\sqrt{Nss}} exp ( - 2 π j \frac{nm}{Nss} ) 1 \leq m , n \leq Nss \qquad ( 4 )$$

By using the SVD combiner precoder, the network entity 105-a may be capable of gaining the subspace of the relatively strongest singular vectors as well as ensuring that the different SNRs are balanced per stream. Moreover, having equal SNR across the streams of a signal may ensure that the stream with the relatively weakest or lowest SNR will have an improved SNR. The limiting noise floor may then be reduced and a higher throughput may be conveyed via the precoded signal 225. Further, in the example with an operated MCS having an SNR threshold of 30 dB, having the network entity 105-a utilize a precoder 215 that is an SVD combiner precoder may enable the network entity 105-a to use the operated MCS. The network entity 105-a may then be capable of utilizing a relatively higher MCS when using an SVD combiner precoder due to each stream benefiting from an SNR that is an average SNR (e.g., an average across the streams of a signal).

For example, a signal with four layers with SNR values of 45, 40, 32, and 28, without the SVD combiner precoder, the network entity 105-a may be limited to selecting an MCS associated with a 28 dB SNR threshold. However, when the network entity 105-a utilizes a precoder 215 that operates according to an SVD combiner precoder scheme, the SNRs of each layer may be improved to an SNR value of 32. The network entity 105-a may then be capable of selecting an MCS associated with a 32 dB SNR threshold rather than an MCS associated with a 28 dB SNR threshold, enabling a relatively higher throughput value.

When the SVD combiner precoder is utilized, the UE 115-a may be expected to have the same demodulation performance (e.g., an error vector magnitude (EVM) may be relatively the same when the SNR values are balanced between streams of a signal). Utilization of a precoder 215 that is an SVD combiner precoder may ensure that even the stream with the relatively weakest or lowest SNR is improved such that the network entity 105-a may be capable of using a higher MCS and refraining from having to lower the MCS used. Moreover, utilization of the SVD combiner precoder may guarantee an increase in throughput.

However, although the SVD combiner precoder may increase the throughput, having the network entity 105-a utilize the SVD combiner precoder may increase the demodulation complexity at the decoder 220 of the UE 115-a compared to utilizing an SVD precoder where layers or streams are not combined. For example, while the SVD precoder may generate a MIMO system that is equivalent to the quantity of streams, Nₛₛ, separated SISO links that leads to relatively dramatic demodulation complexity reductions, such SISO property may be unable to be attained for the SVD combiner precoder. The demodulation complexity may then be relatively higher due to the decoder 220 of the UE 115-a having to invert the channel matrix because the channel matrix is not guaranteed to be diagonal.

If the network entity 105-a has to ensure a relatively low complexity for demodulation and decoding based on the capabilities of the UE 115-a, the network entity 105-a may utilize the SVD precoder techniques at the loss of signal capacity due to the non-equal SNR values across the layers of a signal. Moreover, if the UE 115-a is capable of having a relatively higher demodulation complexity for the decoder 220, the network entity 105-a may determine to utilize the SVD combiner precoder techniques to increase the signal capacity by ensuring equal SNR values across the layers of a signal. However, if the UE 115-a is unable to handle the demodulation complexity level associated with the SVD combiner precoder techniques but is capable of handling a demodulation complexity increase compared to the SVD precoder techniques, the network entity 105-a may determine to utilize SVD partial combiner precoder techniques as described in accordance with the techniques of the present disclosure.

As described in accordance with the techniques of the present disclosure, the network entity 105-a may use a precoder 215 that is an SVD partial combiner precoder where the precoder 215 refrains from combining all the streams of a signal and rather generates a partial combination of a subset of the streams. In some examples, when utilizing the SVD partial combiner precoder, the network entity 105-a may be unable to use an equal power entries matrix, rather, the network entity 105-a may utilize a matrix that combines a part of the streams. For example, an additional matrix that the precoder 215 may utilize for matrix multiplication, to combine a first and fourth layer of a signal that has four layers, may be indicated via Equation 5 below.

$$a = [ \begin{matrix}\sqrt{0.5} & 0 & 0 & \sqrt{0.5} \\ 0 & 1 & 0 & 0 \\ 0 & 0 & 1 & 0 \\ \sqrt{0.5} & 0 & 0 & - \sqrt{0.5}\end{matrix} ] \qquad ( 5 )$$

Equation 5 may illustrate a matrix, a, that balances between the strongest and weakest streams (e.g., between a stream or layer associated with a relatively highest SNR value and a stream or layer associated with a relatively lowest SNR value) for a signal with four layers or streams (e.g., Nₛₛ=4). Additionally, or alternatively, it should be noted that the matrix, a, in Equation 5 may represent one example of a matrix that can be utilized for balancing the SNR values of layers of a signal according to a given scenario or channel conditions. For example, for each selection of a, the network entity 105-a may preserve a same transmission power, and the matrix may have independent columns such that the network entity 105-a may gain the subspace of the relatively strongest singular vectors as well as balancing the different SNRs per stream.

In some examples, after SVD, a signal may then have a first layer with an SNR value of 44 dB, a second layer with an SNR value of 33 dB, a third layer with an SNR value of 32 dB, and a fourth layer with an SNR value of 28 dB (e.g., [44, 33, 32, 28] [dB]). In accordance with the techniques of the present disclosure, the network entity 105-a may determine to combine the first and fourth layers of the signal to balance the SNR values of the first and fourth layers. Further, the network entity 105-a may further determine to keep the second and third layers of the signal separated such that the SNR values of the second and third layers of the signal remain the same. The SNR per layer, after the network entity 105-a utilizes the precoder 215 that is an SVD partial combiner precoder, may then be such that the first layer has an SNR value of 32 dB, the second layer has an SNR value of 33 dB, the third layer has an SNR value of 32 dB, and the fourth layer has an SNR value of 32 dB. Moreover, because the second and third layer were not combined by the precoder 215, the second layer and the third layer may retain the SISO SVD gain due to the layer separation. Moreover, due to the SISO SVD gain, the UE 115-a may be capable of demodulating (e.g., via the decoder 220) the second layer and the third layer of the precoded signal 225 relatively more easily. Further, the first layer and the second layer of the precoded signal 225 may also experience some gain compared to combining all the layers of a signal. For example, the demodulation of the precoded signal 225 may include two mixed streams rather than four which may decrease the demodulation complexity of the decoder 220 at the UE 115-a accordingly.

In accordance with the techniques of the present disclosure, having the network entity 105-a utilize, via the precoder 215, SVD partial combination precoding techniques may introduce an intermediate level of separation which can balance the SNR per layer that adds relatively less complexity to the decoder 220 at the UE 115-a compared to full SCD combination precoding techniques. Each of the streams or layers of a signal (e.g., the precoded signal 225) may then be combined with others or may remain separated to provide a tradeoff between demodulation complexity and signal capacity. That is, the signal capacity or the transmission performance of a signal may increase as the quantity of layers combined increases and the complexity of demodulating a signal may decrease as the quantity of layers combined decreases. However, some scenarios may experience different performance or complexity changes when utilizing full layer combination. For example, for the same allocated bandwidth, different bandwidth regions may have relatively SNR differences between layers of a signal due to relatively high differences between the singular values of a channel that can be a result of channel fading.

To improve the SNR differences, the techniques of the techniques of the present disclosure may relate to improving the capacity and complexity tradeoffs with respect to the frequency dimension by configuring different layer combinations for each part of a bandwidth. To improve the capacity and complexity tradeoff, in accordance with the techniques of the present disclosure, the network entity 105-a may provide different level of layers separation per precoding group where each precoding group of a signal includes a subset of layers of the signal. The precoding may the balance the SNR across the different layers for portions (e.g., frequency regions) that expect SNR balancing, avoiding adding additional complexity at portions where SNR balancing may be unexpected or unneeded (e.g., between layers with relatively similar SNR values). Additionally, or alternatively, for frequency regions that already have relatively balanced SNR values, the network entity 105-a may refrain from applying layer combination techniques (e.g., full or partial layer combination techniques), and for other frequency regions with relatively higher SNR imbalances across layers, the network entity 105-a may apply layer combination techniques to improve the signal capacity of such frequency regions.

In accordance with the techniques of the present disclosure, for a signal (e.g., the precoded signal 225) that includes 4 layers, the network entity 105-a may utilize, via the precoder 215, one of a set of layer combination configurations to precode a portion of a signal (e.g., a subset of layers associated with a respective precoding group). For example, the network entity 105-a may precode, via the precoder 215, a subset of layers of a particular precoding group according to a first layer combination configuration where there is full separation between each layer of the subset of layers (e.g., standard SVD techniques where each layer is precoded separately and there is no layer combining). In some examples, the network entity 105-a may precode, via the precoder 215, the subset of layers of the particular precoding group according to a second layer combination configuration that is associated with partial combination. In some examples, when precoding the subset of layers in accordance with the second layer combination configuration, the network entity 105-a may combine the relatively strongest and the relatively weakest layers of a signal (e.g., the layers with the relatively highest and lowest SNR values) and refrain from combining the remaining layers (e.g., the remaining layers may remain separated). For example, for a signal with four layers, a first layer and a fourth layer of a signal may be combined due to the SNR values of the first layer and the fourth layer and the second layer and the third layer may remain separated.

In some examples, the network entity 105-a may precode, via the precoder 215, the subset of layers of the particular precoding group according to a third layer combination configuration that is also associated with partial combination. Similar to the second layer combination configuration, when the network entity 105-a precodes a subset of layers according the third layer combination configuration, the network entity 105-a may combine the relatively strongest and the relatively weakest layers of the subset of layers. However, when utilizing the third layer combination configuration, the network entity 105-a may separately combine the remaining intermediate layers of the subset of layers. For example, the network entity 105-a may precode the subset of layers by combining a first layer and a fourth layer and separately combining a second layer and third layer. The network entity 105-a may then balance the SNR values between the relatively strongest and relatively weakest layers and balance the SNR values between the intermediate layers of a subset of layers. In some examples, the network entity 105-a may precode, via the precoder 215, the subset of layers of the particular precoding group according to a fourth layer combination configuration that is associated with full layer combination (e.g., SVD combiner precoding techniques). For example, for a subset of layers that includes four layers, when utilizing the fourth layer combination configuration, the network entity 105-a may combine all four layers when precoding the subset of layers via the precoder 215.

In some examples, when precoding a signal (e.g., the precoded signal 225), the network entity 105-a may precode the signal on a per precoding group basis. The network entity 105-a may determine to precode, via the precoder 215, each precoding group of a set of precoding groups of a signal separately from each other. Moreover, because the network entity 105-a may precode the signal on the per precoding group basis, the network entity 105-a may, for each precoding group of a set of precoding groups of the signal, determine or select a layer combination configuration to utilize for precoding a particular or respective precoding group that includes a subset of layers of the signal.

In some examples, the network entity 105-a may transmit, to the UE 115-a, an indication of the one or more layer combination configurations used to precode a set of layers of the precoded signal 225 on the per precoding group basis. In some examples, the network entity 105-a may transmit a downlink message 230 to indicate the layer combination configuration utilized for precoding each precoding group of the precoded signal 225. In some examples, the downlink message 230 may be an example of a control message or signal, downlink control information (DCI) message (e.g., a DCI activation or deactivation message), a MAC-control element (MAC-CE) (e.g., a MAC-CE activation or deactivation message), a physical downlink shared channel (PDSCH) message, a physical downlink control channel (PDCCH) message, or any other type of downlink message 230.

In some examples, the downlink message 230 may indicate, for each precoding groups of a set of precoding groups associated with the per precoding group basis, a respective precoding group index and an indication of a respective layer combination configuration of a set of layer combination configuration that includes the one or more layer combination configurations used for precoding the respective subset of layers of the set of layers of the respective precoding group. For example, as illustrated via Table 1 below, the downlink message 230 may include or indicate a table or bitmap that indicates an index of a precoding group and an index of a layer combination configuration that the network entity 105-a used to precode the subset of layers of a precoding group indicated by the index of the precoding group. In some examples, the table or bitmap may indicate the layer combination configuration used to precoded each of the N precoding groups in the precoded signal 225.

TABLE 1

Precoding Group Index

| | 0 | 1 | 2 | 3 | . . . | N-1 |
|---|---|---|---|---|---|---|
| Layer | 1 | 4 | 2 | 1 | . . . | 3 |
| Combination | | | | | | |
| Configuration | | | | | | |
| Index | | | | | | |

In some examples, when transmitting the downlink message 230, the network entity 105-a may utilize information associated with the channel (e.g., the communication link 205 that is provided due to the network entity 105-a and UE 115-a being in a closed loop system) to evaluate the different SNR values per layer (e.g., that correspond to the singular values of the communication link 205 or channel). Utilizing the information across the different precoding groups of an allocated bandwidth, the network entity 105-a may be capable of determining which SNRs should be balanced by combining corresponding layers. In some examples, the network entity 105-a may be configured (e.g., via an RRC configuration) with a balancing policy and an operated MCS. In some examples, the balancing policy may include an SNR imbalance threshold such that the network entity 105-a may refrain from performing any layer combinations until the SNR imbalance threshold is satisfied. For example, the balancing policy of the network entity 105-a may indicate an SNR imbalance threshold of T dB and the network entity 105-a may refrain from utilizing a layer combination configuration that combines layers (e.g., the second layer combination configuration, the third layer combination configuration, or the fourth layer combination configuration) if the SNR imbalance between layers of a precoding group is less than the SNR imbalance threshold. Moreover, if the SNR imbalance threshold is satisfied (e.g., a difference of SNR values of at least two layers in a subset of layers of a precoding group is above the SNR imbalance threshold), the network entity 105-a may utilize a layer combination configuration that combines two or more layers to ensure that the SNR values are balanced between the layers in a subset of layers of a precoding group. Moreover, the network entity 105-a may subsequent transmit the downlink message 230 with an updated indication of the one or more layer combination configurations used to precode the layers of a signal, on a per slot basis (e.g., the network entity 105-a may transmit an update to the downlink message 230 at the start of each slot). Additionally, or alternatively, the network entity 105-a may transmit the downlink message 230 to the network entity 105-a prior to or in conjunction with the precoded signal 225. For example, the network entity 105-a may transmit the downlink message 230 to the network entity 105-a prior to the precoded signal 225 such that the UE 115-a can determine how to decode the precoded signal 225. In some examples, the downlink message 230 may be multiplexed with the precoded signal 225 or the precoded signal 225 and the downlink message 230 may be sent via a single message.

Upon receiving the precoded signal 225, the UE 115-a may utilize the decoder 220 to decode and demodulate the precoded signal 225. In some examples, for layers marked as separated, the UE 115-a may use a relatively simple demodulation procedure via the decoder 220 (e.g., a MMSE demodulation that corresponds to a SISO system). For example, via the downlink message 230, the network entity 105-a may indicate that a respective (e.g., a particular) subset of layers of a respective precoding group is precoded in accordance with the first layer combination configuration (e.g., full layer separation) or in accordance with the second layer combination configuration (e.g., partial layer combination where the intermediate layers are separated). In such examples, the UE 115-a may utilize the relatively simple demodulation procedure to demodulate and decode the separated layers (e.g., the non-combined layers). In some examples, when utilizing the second layer combination configuration, the network entity 105-a may indicate, via the downlink message 230, which layers of the subset of layers of a respective precoding group of the precoded signal 225 are combined and which layers of the subset of layers are separated. In some examples, the UE 115-a may be capable of determining which layers are combined and which layers are separated.

To decode and demodulate the layers marked as combined, the UE 115-a may utilize a lower-noise-enhancement-demodulation procedure (e.g., a demodulation procedure associated with a per-stream recursive demapping (PSRD) procedure). In some examples, when the network entity 105-a combines two or more layers of a subset of layers in a respective precoding group of the precoded signal 225 in accordance with a layer combination configuration (e.g., the second layer combination configuration, the third layer combination configuration, or the fourth layer combination configuration), the network entity 105-a may indicate, via the downlink message 230, which layers are combined. In some examples, the UE 115-a may be capable of determining which layers are combined. Additionally, or alternatively, the UE 115-a may determine to utilize the lower-noise-enhancement-demodulation procedure to decode and demodulate the layers of the precoded signal 225 regardless of an indicated combining level for a precoding group. For example, although the lower-noise-enhancement-demodulation procedure may be relatively more complex than a MMSE demodulation procedure, the lower-noise-enhancement-demodulation procedure may result in a reduced quantity of hypotheses (e.g., due to the PSRD procedure) for the layers marked as separated compared to the layers marked as combined. Moreover, although the lower-noise-enhancement-demodulation procedure may be relatively more complex than a MMSE demodulation procedure, the lower-noise-enhancement-demodulation procedure may provide some complexity reduction for separated layers.

In some examples, the UE 115-a may determine how to utilize the decoder 220 to decode and demodulate the precoded signal 225 based on a configuration of the UE 115-a, capabilities of the UE 115-a, or other limitations. For example, the UE 115-a may be configured to utilize a power saving mode (e.g., a low batter mode) when a power level of the UE 115-a is below a threshold. In some examples, the UE 115-a may determine to transmit an uplink signal 235 to the network entity 105-a, via the communication link 210, to indicate when the UE 115-a enters or exits a power saving or low batter mode. For example, if the UE 115-a is within a power saving mode, the UE 115-a may be unable to decode and demodulate the precoded signal 225 if any of the layers are combined due to the increased demodulation complexity. By having the UE 115-a indicate to the network entity 105-a when the UE 115-a enters or exits a power saving mode, the network entity 105-a may further be capable of selecting a respective layer combination configuration to utilize for precoding the precoded signal 225 on the per precoding group basis. In some examples, the UE 115-a may transmit a capability message 240 (e.g., capability reporting) to the network entity 105-a via the communication link 210 to indicate one or more capabilities of the UE 115-a. For example, the capability message 240 may indicate a maximum power level of the UE 115-a, a recharging schedule of the UE 115-a, information associated with the capabilities of the decoder 220 at the UE 115-a, or any combination thereof. In such examples, the network entity 105-a may determine which layer combination configuration to utilize for precoding each precoding group of the precoded signal 225 based on the uplink signal 235, the capability message 240, or both.

In some examples, the UE 115-a may have limited capabilities (e.g., hardware capabilities, software capabilities, or a combination thereof) and the UE 115-a may transmit a layer combination configuration request message 245 to the network entity 105-a via the communication link 210. For example, if the UE 115-a has a power level below a threshold power level (e.g., a low battery level), the UE 115-a may transmit the layer combination configuration request message 245 to request that the network entity 105-a to refrain from combining layers when precoding the precoded signal 225. In some examples, the network entity 105-a may receive the layer combination configuration request message 245 and then determine to precode the precoded signal 225 using the first layer combination configuration where each layer of a subset of layers in a precoding group is separated. The UE 115-a may be then capable of decoding the precoded signal 225 via the decoder 220 utilizing a relatively reduced demodulation complexity. Additionally, or alternatively, once the power level of the UE 115-a satisfies the threshold power level, the UE 115-a may transmit the layer combination configuration request message 245 to the network entity 105-a to indicate that the network entity 105-a can select from any of the layer combination configurations again. For example, the UE 115-a may enter a recharging state and after fully charged, charged above a threshold, or while recharging, the UE 115-a may transmit the layer combination configuration request message 245 to request a reactivation of the techniques of the present disclosure associated with combining the subset of layers in respective precoding groups of a signal (e.g., the 225//) either partially or completely.

In some examples, to improve the spectral efficiency and reduce the power consumption at the UE 115-a, the network entity 105-a may reduce the overall overhead of the downlink message 230. For example, in accordance with the techniques of the present disclosure, the network entity 105-a may provide a determination or indication of a respective layer combination configuration used per two or more precoding groups. For example, rather than indicating the layer combination configuration used to precode each precoding group of the precoded signal 225, the network entity 105-a may utilize a same layer combination configuration per K₁ precoding groups. The network entity 105-a may then indicate, via the downlink message 230, the respective layer combination configuration used to precode each K₁ precoding group index, reducing the size of the downlink message 230 by K₁.

In some examples, rather than updating the precoding determinations each slot, the network entity 105-a may determine to update the determination each K₂ slots. For example, the network entity 105-a may transmit the downlink message 230 every K₂ slots and may utilize the same signal precoding configuration for each signal transmitted prior to the next (e.g., subsequent) transmission of the downlink message 230 that indicates an updated signal precoding configuration. For example, if K₂ is equal to four, the network entity 105-a may transmit the downlink message 230 indicating a first precoding configuration at a first slot that indicated the respective layer combination configuration used to precoded each precoding group of a signal. Moreover, the network entity 105-a may precode each signal transmitted between the first and the fourth slot in accordance with the first precoding configuration. Then the network entity 105-a may transmit a second precoding configuration at a fourth slot indicate a second precoding configuration that may indicate one or more updates on the respective layer combination configuration used to precoded each precoding group of a signal.

In some examples, to reduce the signaling overhead, the network entity 105-a may refrain from indicating respective precoding groups where layers of the subset of layers are fully separated (e.g., precoding groups precoded in accordance with the first layer combination configuration). That is, the network entity 105-a may only indicate, via the downlink message 230, the precoding groups that expect SNR balancing (e.g., layer combinations). In some examples, if most precoding groups are capable of being precoded without SNR balancing, such signaling approach may reduce the signaling overhead relatively drastically. For example, the precoded signal 225 may be associated with 10 precoding groups and the network entity 105-a may utilize a respective layer combination configuration that combines two or more layers for 2 of the 10 precoding groups. The network entity 105-a may then transmit, for the corresponding 2 precoding groups and via the downlink message 230, an indication of a respective precoding group index and a respective layer combination configuration used to precode the respective subset of layers associated with a respective precoding group indicated via the respective precoding group index. The downlink message 230 may then include two precoding group indications rather than 10 precoding group indications, reducing the overhead of the downlink message 230.

In some examples, the network entity 105-a may transmit, via the downlink message 230, an indication of respective precoding groups where layers of the subset of layers are fully separated (e.g., precoding groups precoded in accordance with the first layer combination configuration) and refrain from indicating the respective precoding groups that experience SNR balancing. That is, the network entity 105-a may transmit, via the downlink message 230, an indication of only the precoding groups that do not need SNR balancing or do not need to have any layers combined. For example, if the precoded signal 225 includes 10 precoding groups and 2 of the precoding groups are precoded in accordance with a layer combination configuration where each layer of a subset of layers in a respective precoding group are precoded separately, the network entity 105-a may transmit, via the downlink message 230, an indication of the two precoding groups. Moreover, such signaling approach may reduce the signaling overhead when the network entity 105-a expects to perform some SNR balancing or layer combination for most of the precoding groups of a signal when precoding the signal.

In some examples, the network entity 105-a may determine to utilize a same layer combination configuration to precode each precoding group absent from being indicated via the downlink message 230. In such examples, the network entity 105-a may indicate, to the UE 115-a, the layer combination configuration that the network entity 105-a will utilize. In some examples, the network entity 105-a may determine to utilize different layer combination configurations to precode each precoding group absent from being indicated via the downlink message 230. In such examples, based on the capability of the UE 115-a, the UE 115-a may determine which layer combination configuration is utilized to precode each precoding group.

For example, due to the closed-loop system, the UE 115-a may be aware of the channel conditions of both the communication link 205 and the communication link 210 and may be capable of determining which layer combination configuration the network entity 105-a will select or utilize. Additionally, or alternatively, the network entity 105-a may transmit, to the UE 115-a, prior to communications via the communication link 205 and the communication link 210, an indication of the balancing policy configured at the network entity 105-a.

Further, to reduce the quantity of possible layer combination configurations, the network entity 105-a may determine to utilize a subset of layer combination configurations of a set of layer combination configurations. For example, in accordance with the techniques of the present disclosure, the network entity 105-a may determine to utilize the first layer combination configuration and the fourth layer configuration and refrain from utilizing the second layer combination configuration and the third layer combination configuration. The network entity 105-a may further either precode each layer of a subset of layers associated with a precoding group separately or combine each layer together for precoding. In some examples, the network entity 105-a may determine to utilize the second layer combination configuration and the third layer combination and refrain from utilizing the second layer combination configuration and the third layer combination configuration. The network entity 105-a may then combine the relatively strongest and the relatively weakest layers together and either keep the intermediate layers separated or combine the intermediate layers together.

Additionally, or alternatively, because both the network entity 105-a and the UE 115-a may be aware of the channel conditions of the communication link 205 (e.g., the downlink channel) due to the network entity 105-a and UE 115-a being in a closed loop system, the network entity 105-a may transmit, to the UE 115-a, a message, prior to communications via the communication link 205 and the communication link 210, that includes one or more indications associated with how the network entity 105-a may precode a signal. For example, the network entity 105-a may transmit, to the UE 115-a, an indication that the network entity 105-a utilizes a precoder 215 that is capable of utilizing one or more layer combination configurations and which one or more layer combination configurations from a set of layer combination configurations that the network entity 105-a can utilize via the precoder 215. In some examples, the network entity 105-a may transmit, to the UE 115-a, an indication of a policy (e.g., a balancing policy) that the network entity 105-a may utilize to determine which layer combination configuration to use for precoding a respective precoding group. In such examples, the network entity 105-a and the UE 115-a may both be capable of implicitly determining which layer combination configurations are used to precode each precoding group of a set of precoding groups of the precoded signal 225 based on the channel conditions of the communication link 205. The network entity 105-a may then remove the overhead associated with the downlink message 230 based on the network entity 105-a refraining from transmitting the downlink message 230 in such examples.

In some examples, the channel conditions of the communication link 205 may be different at the network entity 105-a and at the UE 115-a. The UE 115-a may determine that a respective precoding group is precoded according to a respective layer combination configuration that is different from the layer combination configuration utilized by the network entity 105-a. In some examples, the UE 115-a may then experience an unnecessary increase in demodulation complexity due to utilizing a higher complexity demodulation procedure via the decoder 220 unnecessarily. In some examples, the UE 115-a may use be unable to correctly decode or demodulation one or more precoding groups due to the determination inaccuracy, resulting in an increase in latency associated with retransmissions of at least portions of the precoded signal 225.

To prevent such unnecessary demodulation increases or increase in communication latency, in accordance with the techniques of the present disclosure the network entity 105-a and the UE 115-a may perform a procedure to validate the determinations. For example, after each change in determinations (e.g., based on channel condition variations or changes), the UE 115-a may transmit, to the network entity 105-a a redundancy check (e.g., one or more CRC bits) over the updated determination. For example, the UE 115-a may concatenate the determination of the layer combination configuration used to precode each precoding group of a signal as indicated by respective precoding group indices together and the UE 115-a may feed the concatenation into a CRC calculator to generate the one or more CRC bits. The network entity 105-a may perform the same CRC calculation and the compare the received message from the UE 115-a to the one or more CRC bits generated by the network entity 105-a. If the network entity 105-a determines that there is a CRC mismatch, the network entity 105-a may determine to precode the corresponding signal according to the first layer combination configuration (e.g., without combining any layers such that each layer is precoded separately) and retransmit the precoded signal 225 to ensure that the UE 115-a accurately decodes the precoded signal 225 via the decoder 220. In some examples, the network entity 105-a may also transmit a feedback message in response to receiving the one or more CRC bits from the UE 115-a. For example, if the network entity 105-a determines that both sets of CRC bits match, the network entity 105-a may transmit an acknowledgment (ACK) message. Moreover, if the network entity 105-a determines that there is a CRC mismatch, the network entity 105-a may transmit a negative acknowledgment (NACK) message and schedule a retransmission of the precoded signal 225, indicate the one or more layer combinations configurations used to precode the precoded signal 225 on the per precoding group basis, or a combination thereof.

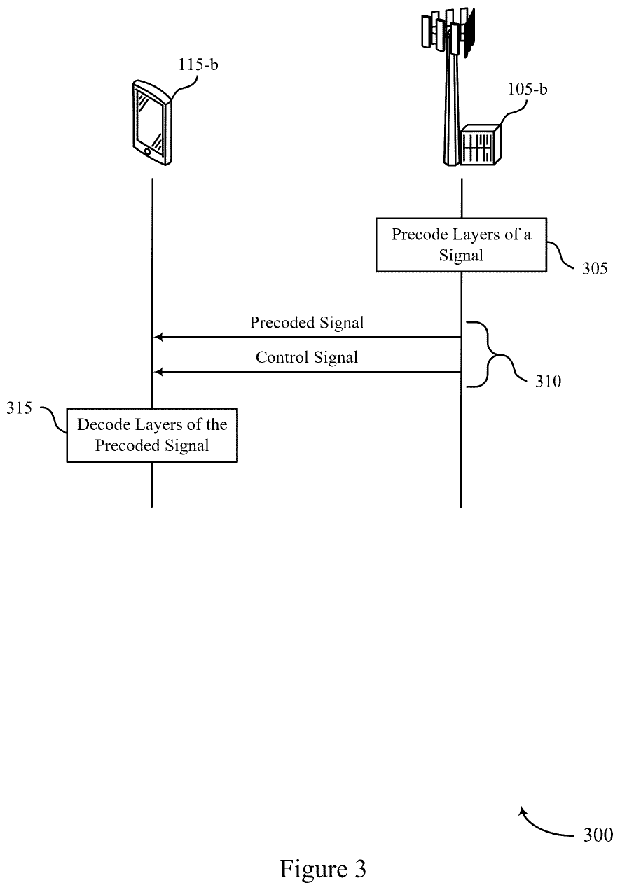

In accordance with the techniques of the present disclosure, the network entity 105-a may be capable of precoding a signal (e.g., the precoded signal 225) in accordance with one or more layer combination configurations on a per precoding group basis to improve the signal capacity and reduce the demodulation complexity at the UE 115-a. For example, because the network entity 105-a may precode subsets of layers associated with precoding groups differently, the UE 115-a may be capable of decoding the subsets of layers differently to reduce the overall demodulation complexity. Moreover, based on receiving the indication of the one or more layer combination configurations used to precoded the set of layers of the precoded signal 225 on the per precoding group or determining the one or more layer combination configurations used, the UE 115-a may be capable of determining relatively more efficient and accurate demodulation techniques or procedures to utilize for decoding each precoding group of the precoded signal 225. The techniques of the present disclosure may decrease the overall demodulation complexity of decoding the precoded signal 225 at the UE 115-a while increasing the overall signal capacity of the precoded signal 225. Further descriptions of the techniques of the present disclosure may be described elsewhere herein, such as with reference to FIGS. 3 through 9.

FIG. 3 shows an example of a process flow 300 that supports signal layer combination precoding indication signaling. In some examples, the process flow 300 may implement or be implemented by the wireless communication system 100, the signaling configuration 200, or both. For example, the process flow 300 may include a UE 115-b and a network entity 105-b, which may be examples of devices described herein with reference to FIGS. 1 and 2.

In the following description of the process flow 300, the operations between the UE 115-b and the network entity 105-b may be performed in different orders or at different times. Some operations may also be left out of the process flow 300, or other operations may be added. Although the UE 115-b and the network entity 105-b are shown performing the operations of the process flow 300, some aspects of some operations may also be performed by one or more other wireless communication devices.

At 305, the network entity 105-b may precode a set of layers of a signal on a per precoding group basis in accordance with one or more layer combination configurations. Further, each precoding group of a set of precoding groups that are associated with the per precoding group basis may include a respective subset of the set of layers. In some examples, the network entity 105-b may select the one or more layer combination configurations for precoding respective subsets of the set of layers associated with the set of precoding groups associated with the per precoding group basis in accordance with a balancing policy, an MCS at the network entity 105-b, or a SNR threshold between layers, or any combination thereof. In some examples, the network entity 105-b may receive, from the UE 115-b, an uplink signal associated with a change to a power-saving mode at the UE 115-b. In such examples, the network entity 105-b may precode the set of layers of the signal on the per precoding group basis in accordance with the one or more layer combination configurations in association with the reception of the uplink signal. In some examples, the network entity 105-b may receive, from the UE 115-b, a message indicating one or more capabilities of the UE 115-b. In some examples, the capabilities of the UE 115-b may be associated with a power level of the UE 115-b, support for a power-saving mode at the UE 115-b, or support for a recharging mode at the UE 115-b, or any combination thereof. Moreover, the network entity 105-b may precode the set of layers of the signal on the per precoding group basis in accordance with the one or more layer combination configurations in accordance with the one or more capabilities of the UE. Additionally, or alternatively, the network entity 105-b may receive, from the UE 115-b, a request for the network entity 105-b to use a particular layer combination configuration of the one or more layer combination configurations. The network entity 105-b may then precode the set of layers of the signal on the per precoding group basis in accordance with the particular layer combination configuration in association with the reception of the request. Further, the request may be associated with a change in capabilities at the UE 115-b, or a change in a power-saving mode at the UE 115-b, or any combination thereof.

In some examples, the network entity 105-b may precode each layer of the respective subset of the set of layers of a respective precoding group separately in accordance with a respective layer combination configuration of the one or more layer combination configurations (e.g., the first layer combination configuration). In some examples, the network entity 105-b may combine, for a first precoding group of the set of precoding groups, a first layer of the respective subset of the set of layers of the first precoding group with a second layer of the respective subset of the set of layers of the first precoding group in accordance with a respective layer combination configuration of the one or more layer combination configurations (e.g., the second layer combination configuration). Moreover, the network entity 105-b may precode a remaining one or more layers of the respective subset of the set of separately in accordance with the respective layer combination configuration.

In some examples, the network entity 105-b may combine, for a first precoding group of the set of precoding groups, a first portion of the respective subset of the set of layers with a second portion of the respective subset of the set of layers in accordance with a respective layer combination configuration of the one or more layer combination configurations (e.g., the third layer combination configuration). Further, the second portion comprising one or more layers of the respective subset of the set of layers may be different from the first portion of the respective subset of the set of layers. Moreover, the network entity 105-b may precode the first portion of the respective subset of the set of layers separately from the second portion of the respective subset of the set of layers in accordance with the respective layer combination configuration. Additionally, or alternatively, the network entity 105-b may combine, for a first precoding group, each layer of the respective subset of the set of layers of the first precoding group in accordance with a respective layer combination configuration of the one or more layer combination configurations (e.g., the fourth layer combination configuration).

At 310, the network entity 105-b may transmit, to the UE 115-b, the precoded set of layers of the signal and an indication of the one or more layer combination configurations used to precode the set of layers on the per precoding group basis. In some examples, the network entity 105-b may transmit the indication of the one or more layer combination configurations used to precode the set of layers of the signal in accordance with a slot periodicity, the slot periodicity including two or more slots. In some examples, the indication of the one or more layer combination configurations may include an indication of a subset of precoding groups, where the subset of precoding groups are in accordance with an SNR threshold. In some examples, a quantity of the one or more layer combination configurations that the network entity 105-b may indicate to the UE 115-b may be associated with one or more capabilities of the network entity 105-b associated with a precoder at the network entity 105-b.

In some examples, the indication of the one or more layer combination configurations that are associated with a first precoding group may include an indication that the network entity 105-b may combine a first layer and a second layer separately from a remaining one or more layers of the respective subset of the set of layers and that the network entity 105-b may precode each layer of the remaining one or more layers separately in accordance with a respective layer combination configuration. In some examples, the indication of the one or more layer combination configurations that is associated with a first precoding group may include an indication that the network entity 105-b may combine a first portion of the respective subset of the set of layers and precoded the combined first portion separately from a second portion of the respective subset of the set of layers in accordance with a respective layer combination configuration. In some examples, the indication of the one or more layer combination configurations associated with a first precoding group may include an indication that the network entity 105-b combined each layer of a respective subset of the set of layers of a first precoding group in accordance with a respective layer combination configuration.

In some examples, the network entity 105-b may transmit, to the UE 115-a, a downlink message prior to or with the precoded set of layers of the signal. In some examples, the downlink message may include, for each precoding group of the set of precoding groups associated with the precoding group basis, a respective precoding group index and an indication of a respective layer combination configuration, of a set of layer combination configurations that includes the one or more layer combination configurations, for precoding the respective subset of the set of layers of a respective precoding group. In some examples, the downlink message may include, for the precoding group basis, an indication of two or more respective precoding group indices and an indication of a respective layer combination configuration of a set of layer combination configurations that includes the one or more layer combination configurations for precoding the respective subset of the set of layers of two or more respective precoding groups.

At 315, the UE 115-b may decode, at the UE 115-b and on the per precoding group basis, a set of layers of the signal in accordance with the indication of the one or more layer combination configurations used to precode the set of layers on the per precoding group basis. In some examples, the set of layers decoded at 315 is the same as (e.g., corresponds directly to) the set of layers precoded at 305.

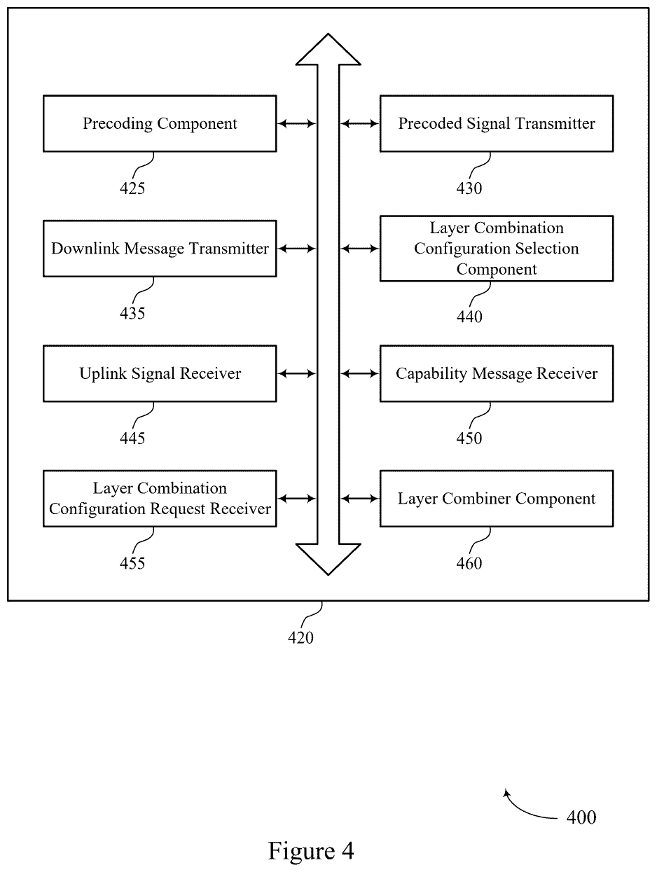

FIG. 4 shows an example of a processing system 420 that supports signal layer combination precoding indication signaling. A processing system 420 may be an example of a processing system 145 (such as network entity 105) and may include a precoding component 425, a precoded signal transmitter 430, a downlink message transmitter 435, a layer combination configuration selection component 440, an uplink signal receiver 445, a capability message receiver 450, a layer combination configuration request receiver 455, a layer combiner component 460, or any combination thereof. A processing system 420, or various component thereof, may be an example of means for performing (such as a means for causing a network entity 105 to perform) various techniques described herein.

The precoding component 425 may be configured to cause the network entity 105 to precode, at the network entity, a set of multiple layers of a signal on a per precoding group basis in accordance with one or more layer combination configurations, each precoding group of a set of multiple precoding groups associated with the per precoding group basis including a respective subset of the set of multiple layers. The precoded signal transmitter 430 may be configured to cause the network entity 105 to transmit, to a UE, the precoded set of multiple layers of the signal and an indication of the one or more layer combination configurations used to precode the set of multiple layers on the per precoding group basis.

In some examples, to support indication of the one or more layer combination configurations, the downlink message transmitter 435 may be configured to cause the network entity 105 to transmit a downlink message to the UE prior to or with the precoded set of multiple layers of the signal, the downlink message including, for each precoding group of the set of multiple precoding groups associated with the per precoding group basis, a respective precoding group index and an indication of a respective layer combination configuration, of a plurality of layer combination configurations that includes the one or more layer combination configurations, for precoding the respective subset of the set of multiple layers of a respective precoding group.

In some examples, the layer combination configuration selection component 440 may be configured to cause the network entity 105 to select the one or more layer combination configurations for precoding respective subsets of the set of multiple layers associated with the plurality of precoding groups associated with the per precoding group basis in accordance with a balancing policy, a modulation and coding scheme at the network entity, or a signal to noise ratio threshold between layers, or any combination thereof.

In some examples, the uplink signal receiver 445 may be configured to cause the network entity 105 to receive, from the UE, an uplink signal associated with a change to a power-saving mode at the UE, where the set of multiple layers of the signal are precoded on the per precoding group basis in accordance with the one or more layer combination configurations in association with the reception of the uplink signal.

In some examples, the capability message receiver 450 may be configured to cause the network entity 105 to receive, from the UE, a message indicating one or more capabilities of the UE, the one or more capabilities of the UE associated with a power level of the UE, support for a power-saving mode at the UE, or support for a recharging mode at the UE, or any combination thereof, where the set of multiple layers of the signal are precoded on the per precoding group basis in accordance with the one or more layer combination configurations in accordance with the one or more capabilities of the UE.

In some examples, the layer combination configuration request receiver 455 may be configured to cause the network entity 105 to receive, from the UE, a request for the network entity to use a particular layer combination configuration of the one or more layer combination configurations, where the set of multiple layers of the signal are precoded on the per precoding group basis in accordance with the particular layer combination configuration in association with the reception of the request.

In some examples, the request is associated with a change in capabilities at the UE, or a change in a power-saving mode at the UE, or any combination thereof.

In some examples, to support indication of the one or more layer combination configurations, the downlink message transmitter 435 may be configured to cause the network entity 105 to transmit a downlink message to the UE prior to or along with the set of multiple layers of the signal, the downlink message including, for a precoding group basis, an indication of two or more precoding group indices f and an indication of a respective layer combination configuration, of a plurality of layer combination configurations that includes the one or more layer combination configurations, for precoding the respective subset of the set of multiple layers of two or more respective precoding groups.

In some examples, the indication of the one or more layer combination configurations used to precode the set of multiple layers of the signal is transmitted in accordance with a slot periodicity, the slot periodicity including two or more slots.

In some examples, to support indication of the one or more layer combination configurations, the precoding component 425 may be configured to cause the network entity 105 to an indication of a subset of precode groups, wherein the subset of precoding groups is in accordance with a signal to noise ratio threshold.

In some examples, a quantity of the one or more layer combination configurations indicated to the UE is associated with one or more capabilities of the network entity associated with a precoder at the network entity.

In some examples, each layer of the respective subset of the set of multiple layers of a respective precoding group is precoded separately in accordance with a respective layer combination configuration of the one or more layer combination configurations.

In some examples, the layer combiner component 460 may be configured to cause the network entity 105 to combine, for a first precoding group of the plurality of precoding groups, a first layer of the respective subset of the set of multiple layers of the first precoding group with a second layer of the respective subset of the set of multiple layers of the first precoding group in accordance with a respective layer combination configuration of the one or more layer combination configurations, where the indication of the one or more layer combination configurations that is associated with the respective precoding group includes an indication that the first layer and the second layer are combined separately from a remaining one or more layers of the respective subset of the set of multiple layers and that each layer of the remaining one or more layers are precoded separately in accordance with the respective layer combination configuration.

In some examples, the layer combiner component 460 may be configured to cause the network entity 105 to combine, for a first precoding group of the plurality of precoding groups, a first portion of the respective subset of the set of multiple layers with a second portion of the respective subset of the set of multiple layers in accordance with a respective layer combination configuration, the second portion including one or more layers of the respective subset of the set of multiple layers different from the first portion of the respective subset of the set of multiple layers, where the indication of the one or more layer combination configurations that is associated with the first precoding group includes an indication that the first portion of the respective subset of the set of multiple layers is combined and precoded separately from the second portion of the respective subset of the set of multiple layers in accordance with the respective layer combination configuration.

In some examples, the layer combiner component 460 may be configured to cause the network entity 105 to combine, for a first precoding group of the plurality of precoding groups, each layer of the respective subset of the set of multiple layers of the first precoding group in accordance with a respective layer combination configuration of the one or more layer combination configurations, where the indication of the one or more layer combination configurations associated with the first precoding group includes an indication that each layer of the respective subset of the set of multiple layers of the first precoding group are combined in accordance with the respective layer combination configuration.

A processing system 420 may include or be an example of one or more chips, SoCs, chipsets, packages, components, or devices that individually or collectively constitute or include a processing system. A processing system 420 may interface with other components of a network entity 105. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a network entity 105). Operations described herein with reference to the processing system 420, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 420 for operation in a processing system 420 as described herein, the processing system 420 may support techniques for a signal to be precoded in accordance with one or more layer combination configurations to support reduced processing, reduced power consumption, and more efficient utilization of communication resources,

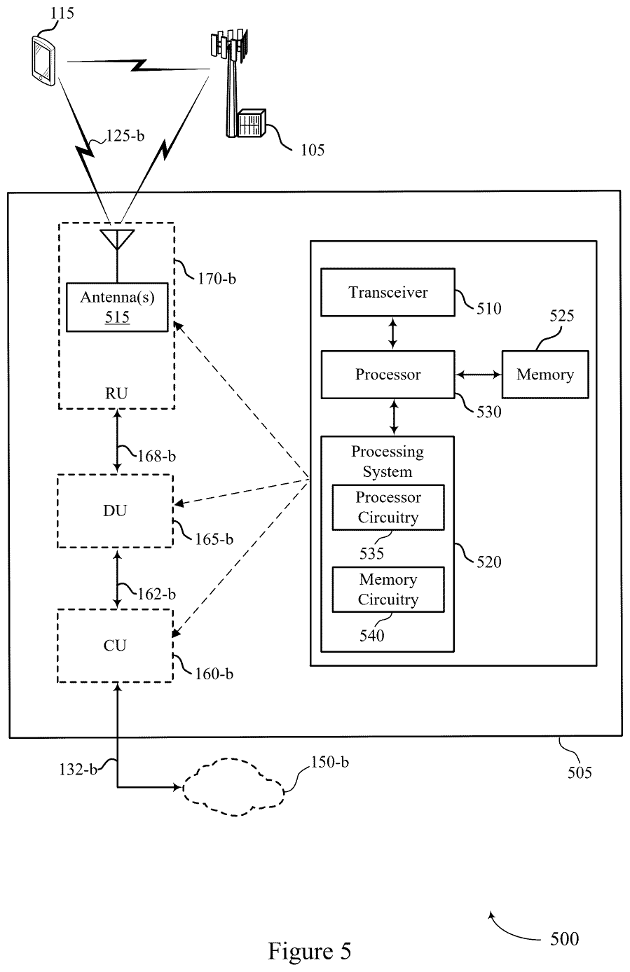

FIG. 5 shows an example of a system 500 including a device 505 that supports signal layer combination precoding indication signaling. The device 505 may communicate (such as via one or more wired interfaces or one or more wireless interfaces) with other network devices or network equipment such as a core network 150-b, other network entities 105, UEs 115, or any combination thereof. The device 505 may include components for transmitting and receiving communication, which may include a processing system 520, a transceiver 510, antenna(s) 515, a memory 525, and a processor 530. Components of the device 505 may be coupled (such as operatively, communicatively, functionally, electronically, electrically, in electronic communication) via one or more interfaces.

The transceiver 510 may communicate bi-directionally with another transceiver via wired or wireless links, and may support transmission operations, reception operations, or both, as described herein. The transceiver 510 may include a modem to modulate and demodulate signals, to provide the modulated signals for transmission (such as via antenna(s) 515, via a wired interface), and to demodulate received signals (such as received via antenna(s) 515, received via a wired interface). The transceiver 510 may be operable to support communication via one or more communication links (such as a communication link 125-b, a backhaul link 132-b, a midhaul link 162-b, fronthaul link 168-b).

The processor 530 may be a general-purpose processing component that supports various operations (such as applications) of the device 505. The memory 525 may be a general-purpose storage component that stores code executable by the processor 530. Such code may include instructions that, when executed by the processor 530, cause the device 505 to perform various functions (such as to support an application of the device 505).

For examples in which the device 505 is a network entity 105 in a disaggregated architecture, one or more components of the device 505 may be located at one or more of a CU 160-b, a DU 165-b, or an RU 170-b, one or more of which may include aspects of the processing system 520, the processor 530, the memory 525, or the transceiver 510. Functions of the device 505 may be performed at different components or an operation may be divided between different components (such as different functions being supported by aspects of the CU 160-b, the DU 165-b, or the RU 170-b, the transceiver 510, the processor 530, the memory 525, the processing system 520, or any combination thereof). For example, the processing system 520 may be a component of one or more of the CU 160-b, the DU 165-b, or the RU 170-b. In some examples, interfaces between components of device 505 (such as CU 160-b, DU 165-b, RU 170-b) may support communication at a protocol layer or between protocol layers of a protocol stack.

In some examples, the processing system 520 may manage aspects of communication with the core network 150-b (such as via a backhaul link 132). For example, the processing system 520 may manage the transfer of data communication for UEs 115 with a gateway of the core network 150-b. In some examples, the processing system 520 may manage communication with one or more other network entities 105 and may include a controller or scheduler for controlling communication with UEs 115 (such as in cooperation with the one or more other network entities 105). In some examples, the processing system 520 may support an interface (such as X2 interface, Xn interface) to provide communication between network entities 105.

The processing system 520 may be an example of a processing system 145 or a processing system 400. For example, the processing system 520 may include processor circuitry 535 and memory circuitry 540 that stores code, and the processing system 520 may be configured to cause the device 505 to perform operations that support signal layer combination precoding indication signaling. Although the processing system 520 is illustrated as a separate component, which may involve a separate chip, chipset, or other module, in some implementations, one or more functions described with reference to the processing system 520 may be supported by or performed by a transceiver 510, antenna(s) 515, a processor 530, memory 525, or any combination thereof, such that a processing system 520 may include one or more of a transceiver 510, antenna(s) 515, a processor 530, memory 525, or any combination thereof. Further, processor circuitry 535 and memory circuitry 540 each may be implemented at the device 505 in accordance with an aggregated architecture, or the processor circuitry 535 and the memory circuitry 540 may be implemented at one or more of a CU 160-b, a DU 165-b, or an RU 170-b in accordance with a disaggregated architecture.

By including or configuring the processing system 520 for operation in the device 505 as described herein, may support techniques for a signal to be precoded in accordance with one or more layer combination configurations to support improved communication reliability, reduced latency, improved user experience related to reduced processing, reduced power consumption, more efficient utilization of communication resources, improved coordination between devices, longer battery life, and improved utilization of processing capability.

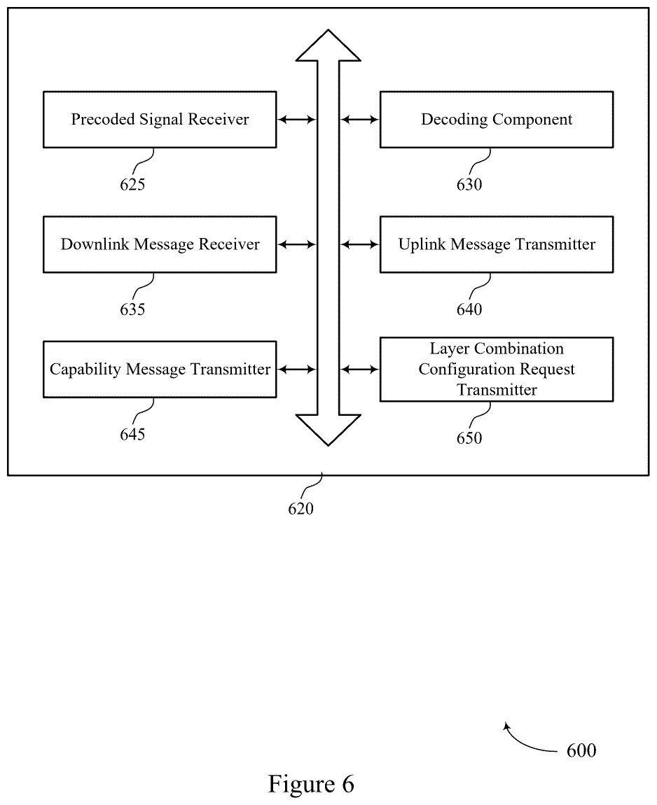

FIG. 6 shows an example of a processing system 620 that supports signal layer combination precoding indication signaling. A processing system 620 may be an example of a processing system 140 (such as of a UE 115) and may include a precoded signal receiver 625, a decoding component 630, a downlink message receiver 635, an uplink message transmitter 640, a capability message transmitter 645, a layer combination configuration request transmitter 650, or any combination thereof. A processing system 620, or various component thereof, may be an example of means for performing (such as a means for causing a UE 115 to perform) various techniques described herein.

The precoded signal receiver 625 may be configured to cause the UE 115 to receive, from a network entity, a precoded set of multiple layers of a signal that is precoded on a per precoding group basis in accordance with one or more layer combination configurations and an indication of the one or more layer combination configurations used to precode the set of multiple layers of the signal, each precoding group of a set of multiple precoding groups associated with the per precoding group basis including a respective subset of the precoded set of multiple layers. The decoding component 630 may be configured to cause the UE 115 to decode, at the UE and on the per precoding group basis, the precoded set of multiple layers of the signal in accordance with the indication of the one or more layer combination configurations used to precode the precoded set of multiple layers on the per precoding group basis.

In some examples, to support indication of the one or more layer combination configurations, the downlink message receiver 635 may be configured to cause a downlink message from the network entity to be received prior to or along with the precodedset of multiple layers of the signal, the downlink message including, for each precoding group of the set of multiple preciding groups associated with the per precoding group basis, a respective precoding group index and an indication of a respective layer combination configuration, of a plurality of layer combination configurations that includes the one or more layer combination configurations, for precoding the respective subset of the precoded set of multiple layers of a respective precoding group.

In some examples, the uplink message transmitter 640 may be configured to cause the UE 115 to transmit, to the network entity, an uplink signal associated with a change to a power-saving mode at the UE, where the indication of the one or more layer combination configurations used to precode the precoded set of multiple layers of the signal is accordance with the change to the power-saving mode at the UE.

In some examples, the capability message transmitter 645 may be configured to cause the UE 115 to transmit, to the network entity, a message indicating one or more capabilities of the UE, the one or more capabilities of the UE associated with a power level of the UE, support for a power-saving mode at the UE, or support for a recharging mode at the UE, or any combination thereof, where the indication of the one or more layer combination configurations used to precode the precoded set of multiple layers of the signal is accordance with the one or more capabilities of the UE.

In some examples, the layer combination configuration request transmitter 650 may be configured to cause the UE 115 to transmit, to the network entity, a request for the network entity to use a particular layer combination configuration of the one or more layer combination configurations, where the indication of the one or more layer combination configurations used to precode the precoded set of multiple layers of the signal is in accordance with the request.

In some examples, the request is associated with a change in capabilities at the UE, or a change in a power-saving mode at the UE, or any combination thereof.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for a signal to be precoded in accordance with one or more layer combination configurations to support reduced processing, reduced power consumption, and more efficient utilization of communication resources.

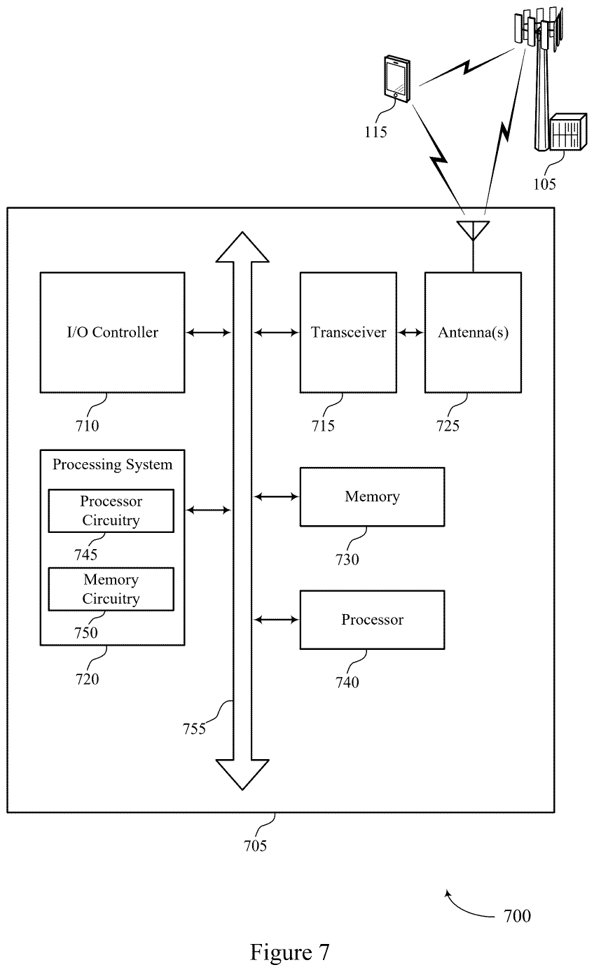

FIG. 7 shows an example of a system 700 including a device 705 that supports signal layer combination precoding indication signaling. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support signal layer combination precoding indication signaling. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for a signal to be precoded in accordance with one or more layer combination configurations to support improved communication reliability, reduced latency, improved user experience related to reduced processing, reduced power consumption, more efficient utilization of communication resources, improved coordination between devices, longer battery life, and improved utilization of processing capability.

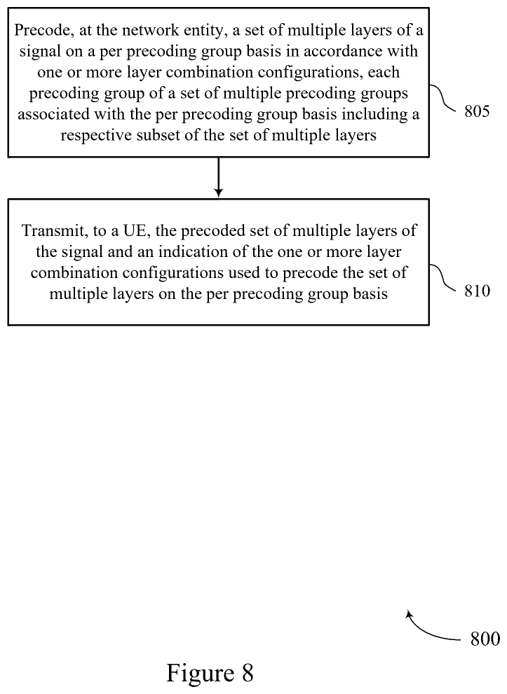

FIG. 8 shows an example of a method 800 that supports signal layer combination precoding indication signaling. Operations of the method 800 may be performed by a network entity 105 or its components (such as using a processing system configured to cause the network entity to perform one or more operations) as described herein.

At 805, the method may include precoding, at the network entity, a set of multiple layers of a signal on a per precoding group basis in accordance with one or more layer combination configurations, each precoding group of a set of multiple precoding groups associated with the per precoding group basis including a respective subset of the set of multiple layers. In some examples, aspects of the operations of 805 may be performed by a precoding component 425.

At 810, the method may include transmitting, to a UE, the precoded set of multiple layers of the signal and an indication of the one or more layer combination configurations used to precode the set of multiple layers on the per precoding group basis. In some examples, aspects of the operations of 810 may be performed by a precoded signal transmitter 430.

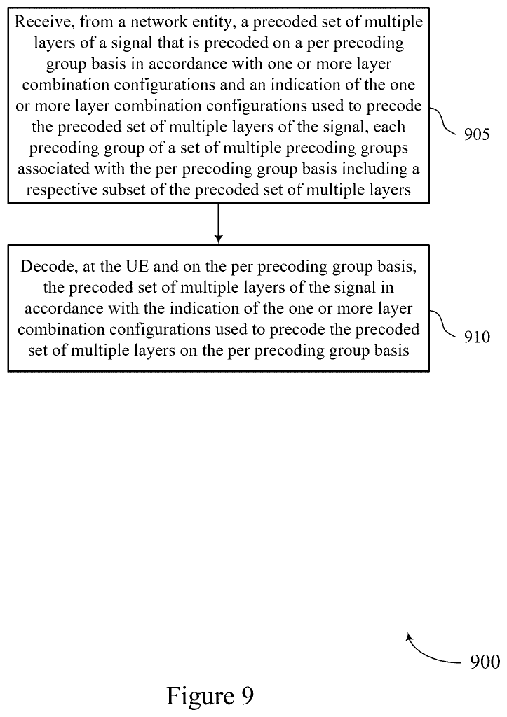

FIG. 9 shows an example of a method 900 that supports signal layer combination precoding indication signaling. Operations of the method 900 may be performed by a UE or its components (such as using a processing system configured to cause the UE 115 to perform one or more of the operations) as described herein.

At 905, the method may include receiving, from a network entity, a precoded set of multiple layers of a signal that is precoded on a per precoding group basis in accordance with one or more layer combination configurations and an indication of the one or more layer combination configurations used to precode the set of multiple layers of the signal, each precoding group of a set of multiple precoding groups associated with the per precoding group basis including a respective subset of the precoded set of multiple layers. In some examples, aspects of the operations of 905 may be performed by a precoded signal receiver 625.

At 910, the method may include decoding, at the UE and on the per precoding group basis, the precoded set of multiple layers of the signal in accordance with the indication of the one or more layer combination configurations used to precode the precoded set of multiple layers on the per precoding group basis. In some examples, aspects of the operations of 910 may be performed by a decoding component 630.

Aspect 1: A method for wireless communications by a network entity, comprising: precoding, at the network entity, a plurality of layers of a signal on a per precoding group basis in accordance with one or more layer combination configurations, each precoding group of a plurality of precoding groups associated with the per precoding group basis comprising a respective subset of the plurality of layers; and transmitting, to a UE, the precoded plurality of layers of the signal and an indication of the one or more layer combination configurations used to precode the plurality of layers on the per precoding group basis.

Aspect 2: The method of aspect 1, wherein the indication of the one or more layer combination configurations comprises: a downlink message transmitted to the UE prior to or with the precoded plurality of layers of the signal, the downlink message comprising, for each precoding group of the plurality of precoding groups associated with the per precoding group basis, a respective precoding group index and an indication of a respective layer combination configuration, of a plurality of layer combination configurations that includes the one or more layer combination configurations used to precoded the respective subset of the plurality of layers of a respective precoding group.

Aspect 3: The method of any of aspects 1 through 2, further comprising: selecting the one or more layer combination configurations for precoding respective subsets of the plurality of layers associated with the plurality of precoding groups associated with the per precoding group basis in accordance with a balancing policy, a modulation and coding scheme at the network entity, or a signal to noise ratio threshold between layers, or any combination thereof.

Aspect 4: The method of any of aspects 1 through 3, further comprising: receiving, from the UE, an uplink signal associated with a change to a power-saving mode at the UE, wherein the plurality of layers of the signal are precoded on the per precoding group basis in accordance with the one or more layer combination configurations in association with the reception of the uplink signal.

Aspect 5: The method of any of aspects 1 through 4, further comprising: receiving, from the UE, a message indicating one or more capabilities of the UE, the one or more capabilities of the UE associated with a power level of the UE, support for a power-saving mode at the UE, or support for a recharging mode at the UE, or any combination thereof, wherein the plurality of layers of the signal are precoded on the per precoding group basis in accordance with the one or more layer combination configurations in accordance with the one or more capabilities of the UE.

Aspect 6: The method of any of aspects 1 through 5, further comprising: receiving, from the UE, a request for the network entity to use a particular layer combination configuration of the one or more layer combination configurations, wherein the plurality of layers of the signal are precoded on the per precoding group basis in accordance with the particular layer combination configuration in association with the reception of the request.

Aspect 7: The method of aspect 6, wherein the request is associated with a change in capabilities at the UE, or a change in a power-saving mode at the UE, or any combination thereof.

Aspect 8: The method of any of aspects 1 through 7, wherein the indication of the one or more layer combination configurations comprises: a downlink message transmitted to the UE prior to or along with the precoded plurality of layers of the signal, the downlink message comprising, for the per precoding group basis, an indication of two or more respective precoding group indices and an indication of a respective layer combination configuration of a plurality of layer combination configurations that includes the one or more layer combination configurations for precoding the respective subset of the plurality of layers of two or more respective precoding groups.

Aspect 9: The method of any of aspects 1 through 8, wherein the indication of the one or more layer combination configurations used to precode the plurality of layers of the signal is transmitted in accordance with a slot periodicity, the slot periodicity comprising two or more slots.

Aspect 10: The method of any of aspects 1 through 9, wherein the indication of the one or more layer combination configurations comprises: an indication of a subset of precoding groups, wherein the subset of precoding groups is in accordance with a signal to noise ratio threshold.

Aspect 11: The method of any of aspects 1 through 10, wherein a quantity of the one or more layer combination configurations indicated to the UE is associated with one or more capabilities of the network entity associated with a precoder at the network entity.

Aspect 12: The method of any of aspects 1 through 11, wherein each layer of the respective subset of the plurality of layers of a respective precoding group is precoded separately in accordance with a respective layer combination configuration of the one or more layer combination configurations.

Aspect 13: The method of any of aspects 1 through 11, further comprising: combine, for a first precoding group of the plurality of precoding groups, a first layer of the respective subset of the plurality of layers of the first precoding group with a second layer of the respective subset of the plurality of layers of the first precoding group in accordance with a respective layer combination configuration of the one or more layer combination configurations, wherein the indication of the one or more layer combination configurations that is associated with the first precoding group comprises an indication that the first layer and the second layer are combined separately from a remaining one or more layers of the respective subset of the plurality of layers and that each layer of the remaining one or more layers are precoded separately in accordance with the respective layer combination configuration.

Aspect 14: The method of any of aspects 1 through 11, further comprising: combining, for a first precoding group of the plurality of precoding groups, a first portion of the respective subset of the plurality of layers with a second portion of the respective subset of the plurality of layers in accordance with a respective layer combination configuration of the one or more layer combination configurations, the second portion comprising one or more layers of the respective subset of the plurality of layers different from the first portion of the respective subset of the plurality of layers, wherein the indication of the one or more layer combination configurations that is associated with the first precoding group comprises an indication that the first portion of the respective subset of the plurality of layers is combined and precoded separately from the second portion of the respective subset of the plurality of layers in accordance with the respective layer combination configuration.

Aspect 15: The method of any of aspects 1 through 11, further comprising: combining, for a first precoding group, each layer of the respective subset of the plurality of layers of the first precoding group in accordance with a respective layer combination configuration of the one or more layer combination configurations, wherein the indication of the one or more layer combination configurations associated with the first precoding group comprises an indication that each layer of the respective subset of the plurality of layers of the first precoding group are combined in accordance with the respective layer combination configuration.

Aspect 16: A method for wireless communications by a UE, comprising: receiving, from a network entity, a precoded plurality of layers of a signal that is precoded on a per precoding group basis in accordance with one or more layer combination configurations and an indication of the one or more layer combination configurations used to precode the precoded plurality of layers of the signal, each precoding group of a plurality of precoding groups associated with the per precoding group basis comprising a respective subset of the plurality of layers; and decoding, at the UE and on the per precoding group basis, the precoded plurality of layers of the signal in accordance with the indication of the one or more layer combination configurations used to precode the precoded plurality of layers on the per precoding group basis.

Aspect 17: The method of aspect 16, wherein the indication of the one or more layer combination configurations comprises: a downlink message from the network entity that is received prior to or along with the precoded plurality of layers of the signal, the downlink message comprising, for each precoding group of the plurality of precoding groups associated with the per precoding group basis, a respective precoding group index and an indication of a respective layer combination configuration, of a plurality of layer combination configurations that includes the one or more layer combination configurations, for precoding the respective subset of the precoded plurality of layers of a respective precoding group.

Aspect 18: The method of any of aspects 16 through 17, further comprising: transmitting, to the network entity, an uplink signal associated with a change to a power-saving mode at the UE, wherein the indication of the one or more layer combination configurations used to precode the precoded plurality of layers of the signal is accordance with the change to the power-saving mode at the UE.

Aspect 19: The method of any of aspects 16 through 18, further comprising: transmitting, to the network entity, a message indicating one or more capabilities of the UE, the one or more capabilities of the UE associated with a power level of the UE, support for a power-saving mode at the UE, or support for a recharging mode at the UE, or any combination thereof, wherein the indication of the one or more layer combination configurations used to precode the precoded plurality of layers of the signal is accordance with the one or more capabilities of the UE.

Aspect 20: The method of any of aspects 16 through 19, further comprising: transmitting, to the network entity, a request for the network entity to use a particular layer combination configuration of the one or more layer combination configurations, wherein the indication of the one or more layer combination configurations used to precode the plurality of layers of the signal is in association with the request.

Aspect 21: The method of aspect 20, wherein the request is associated with a change in capabilities at the UE, or a change in a power-saving mode at the UE, or any combination thereof.

Aspect 22: A network entity for wireless communications, comprising a processing system that includes processor circuitry and memory circuitry that stores code, the processing system configured to cause the network entity to perform a method of any of aspects 1 through 15.

Aspect 23: A network entity for wireless communications, comprising at least one means for performing a method of any of aspects 1 through 15.

Aspect 24: A non-transitory computer-readable medium storing code for wireless communications, the code comprising instructions executable by one or more processors to perform a method of any of aspects 1 through 15.

Aspect 25: A UE for wireless communications, comprising a processing system that includes processor circuitry and memory circuitry that stores code, the processing system configured to cause the UE to perform a method of any of aspects 16 through 21.

Aspect 26: A UE for wireless communications, comprising at least one means for performing a method of any of aspects 16 through 21.

Aspect 27: A non-transitory computer-readable medium storing code for wireless communications, the code comprising instructions executable by one or more processors to perform a method of any of aspects 16 through 21.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system that includes processor circuitry and memory circuitry that stores code, the processing system configured to cause the network entity to:
precode, at the network entity, a plurality of layers of a signal on a per precoding group basis in accordance with one or more layer combination configurations, each precoding group of a plurality of precoding groups associated with the per precoding group basis comprising a respective subset of the plurality of layers; and
transmit, to a user equipment (UE), precoded plurality of layers of the signal and an indication of the one or more layer combination configurations used to precode the plurality of layers on the per precoding group basis.

2. The network entity of claim 1, wherein the indication of the one or more layer combination configurations comprises:
a downlink message transmitted to the UE prior to or with the precoded plurality of layers of the signal, the downlink message comprising, for each precoding group of the plurality of precoding groups associated with the per precoding group basis, a respective precoding group index and an indication of a respective layer combination configuration, of a plurality of layer combination configurations that includes the one or more layer combination configurations, for precoding the respective subset of the plurality of layers of a respective precoding group.

3. The network entity of claim 1, wherein the processing system is further configured to cause the network entity to:
select the one or more layer combination configurations for precoding respective subsets of the plurality of layers associated with the plurality of precoding groups associated with the per precoding group basis in accordance with a balancing policy, a modulation and coding scheme at the network entity, or a signal to noise ratio threshold between layers, or any combination thereof.

4. The network entity of claim 1, wherein the processing system is further configured to cause the network entity to:
receive, from the UE, an uplink signal associated with a change to a power-saving mode at the UE, wherein the plurality of layers of the signal are precoded on the per precoding group basis in accordance with the one or more layer combination configurations in association with the reception of the uplink signal.

5. The network entity of claim 1, wherein the processing system is further configured to cause the network entity to:
receive, from the UE, a message indicating one or more capabilities of the UE, the one or more capabilities of the UE associated with a power level of the UE, support for a power-saving mode at the UE, or support for a recharging mode at the UE, or any combination thereof, wherein the plurality of layers of the signal are precoded on the per precoding group basis in accordance with the one or more layer combination configurations in accordance with the one or more capabilities of the UE.

6. The network entity of claim 1, wherein the processing system is further configured to cause the network entity to:
receive, from the UE, a request for the network entity to use a particular layer combination configuration of the one or more layer combination configurations, wherein the plurality of layers of the signal are precoded on the per precoding group basis in accordance with the particular layer combination configuration in association with the reception of the request.

7. The network entity of claim 6, wherein the request is associated with a change in capabilities at the UE, or a change in a power-saving mode at the UE, or any combination thereof.

8. The network entity of claim 1, wherein the indication of the one or more layer combination configurations comprises:
a downlink message transmitted to the UE prior to or along with the precoded plurality of layers of the signal, the downlink message comprising, for the per precoding group basis, an indication of two or more respective precoding group indices and an indication of a respective layer combination configuration of a plurality of layer combination configurations that includes the one or more layer combination configurations for precoding the respective subset of the plurality of layers of two or more respective precoding groups.

9. The network entity of claim 1, wherein the indication of the one or more layer combination configurations used to precode the plurality of layers of the signal is transmitted in accordance with a slot periodicity, the slot periodicity comprising two or more slots.

10. The network entity of claim 1, wherein the indication of the one or more layer combination configurations comprises:
an indication of a subset of precoding groups, wherein the subset of precoding groups is in accordance with a signal to noise ratio threshold.

11. The network entity of claim 1, wherein a quantity of the one or more layer combination configurations indicated to the UE is associated with one or more capabilities of the network entity associated with a precoder at the network entity.

12. The network entity of claim 1, wherein each layer of the respective subset of the plurality of layers of a respective precoding group is precoded separately in accordance with a respective layer combination configuration of the one or more layer combination configurations.

13. The network entity of claim 1, wherein the processing system is further configured to cause the network entity to:
combine, for a first precoding group of the plurality of precoding groups, a first layer of the respective subset of the plurality of layers of the first precoding group with a second layer of the respective subset of the plurality of layers of the first precoding group in accordance with a respective layer combination configuration of the one or more layer combination configurations, wherein the indication of the one or more layer combination configurations that is associated with the first precoding group comprises an indication that the first layer and the second layer are combined separately from a remaining one or more layers of the respective subset of the plurality of layers and that each layer of the remaining one or more layers are precoded separately in accordance with the respective layer combination configuration.

14. The network entity of claim 1, wherein the processing system is further configured to cause the network entity to:
combine, for a first precoding group of the plurality of precoding groups, a first portion of the respective subset of the plurality of layers with a second portion of the respective subset of the plurality of layers in accordance with a respective layer combination configuration of the one or more layer combination configurations, the second portion comprising one or more layers of the respective subset of the plurality of layers different from the first portion of the respective subset of the plurality of layers, wherein the indication of the one or more layer combination configurations that is associated with the first precoding group comprises an indication that the first portion of the respective subset of the plurality of layers is combined and precoded separately from the second portion of the respective subset of the plurality of layers in accordance with the respective layer combination configuration.

15. The network entity of claim 1, wherein the processing system is further configured to cause the network entity to:
combine, for a first precoding group, each layer of the respective subset of the plurality of layers of the first precoding group in accordance with a respective layer combination configuration of the one or more layer combination configurations, wherein the indication of the one or more layer combination configurations associated with the first precoding group comprises an indication that each layer of the respective subset of the plurality of layers of the first precoding group are combined in accordance with the respective layer combination configuration.

16. A user equipment (UE), comprising:
a processing system that includes processor circuitry and memory circuitry that stores code, the processing system configured to cause the UE to:
receive, from a network entity, a precoded plurality of layers of a signal that is precoded on a per precoding group basis in accordance with one or more layer combination configurations and an indication of the one or more layer combination configurations used to precode the precoded plurality of layers of the signal, each precoding group of a plurality of precoding groups associated with the per precoding group basis comprising a respective subset of the precoded plurality of layers; and
decode, at the UE and on the per precoding group basis, the precoded plurality of layers of the signal in accordance with the indication of the one or more layer combination configurations used to precode the precoded plurality of layers on the per precoding group basis.

17. The UE of claim 16, wherein the indication of the one or more layer combination configurations comprises:
a downlink message from the network entity that is received prior to or along with the precoded plurality of layers of the signal, the downlink message comprising, for each precoding group of the plurality of precoding groups associated with the per precoding group basis, a respective precoding group index and an indication of a respective layer combination configuration, of a plurality of layer combination configurations that includes the one or more layer combination configurations, for precoding the respective subset of the precoded plurality of layers of a respective precoding group.

18. The UE of claim 16, wherein the processing system is further configured to cause the UE to:
transmit, to the network entity, an uplink signal associated with a change to a power-saving mode at the UE, wherein the indication of the one or more layer combination configurations used to precode the precoded plurality of layers of the signal is accordance with the change to the power-saving mode at the UE.

19. The UE of claim 16, wherein the processing system is further configured to cause the UE to:
transmit, to the network entity, a message indicating one or more capabilities of the UE, the one or more capabilities of the UE associated with a power level of the UE, support for a power-saving mode at the UE, or support for a recharging mode at the UE, or any combination thereof, wherein the indication of the one or more layer combination configurations used to precode the precoded plurality of layers of the signal is accordance with the one or more capabilities of the UE.

20. A method for wireless communications by a network entity, comprising:
precoding, at the network entity, a plurality of layers of a signal on a per precoding group basis in accordance with one or more layer combination configurations, each precoding group of a plurality of precoding groups associated with the per precoding group basis comprising a respective subset of the plurality of layers; and
transmitting, to a user equipment (UE), the precoded plurality of layers of the signal and an indication of the one or more layer combination configurations used to precode the plurality of layers on the per precoding group basis.
